(19) United States
(12) Patent Application Publication
(10) Pub. No.: US 2024/0141236 A1
(43) Pub. Date: May 2, 2024

(54) SYSTEMS AND METHODS FOR PROCESSING WASTE

(71) Applicant: IQ ENERGY INC., Evansburg (CA)

(72) Inventors: Darrell FORD, Alberta (CA); Ken DAVISON, Lake Country (CA)

(73) Assignee: IQ ENERGY INC., Evansburg, AB (CA)

(21) Appl. No.: 18/280,450

(22) PCT Filed: Mar. 16, 2022
(86) PCT No.: PCT/CA2022/050398

§ 371 Date: Sep. 5, 2023

Related U.S. Application Data
(60) Provisional application No. 63/161,901, filed on Mar. 16, 2021.

(51) Int. Cl. C10B 47/44; C10B 53/00; C10B 53/02; C10B 53/07; C10B 57/06; C10B 57/10; C10K 3/04; F23N 1/04; F27B 9/10; F27B 9/24

(52) U.S. Cl. CPC C10B 47/44; C10B 53/00; C10B 53/02; C10B 53/07; C10B 57/06; C10B 57/10; C10K 3/04; F23N 1/042; F27B 9/10; F27B 9/24; F23N 2225/08

(57) ABSTRACT

Systems and methods for generating heat, power, and for processing mixed waste streams, using pyrolysis and one or more pyrolysis systems. A pyrolysis system configured to receive material for pyrolysis, comprising a heating chamber configured to receive a waste gas stream for heating the material and one or more ports for metering fuel and oxidizer to the heating chamber for combustion. A pyrolysis chamber holds the material during pyrolysis in isolation from the hot gas in the heating chamber and is disposed inside the heating chamber to circumferentially heat the material for pyrolysis. A screw conveyer conveys the material through the pyrolysis chamber.

### CROSS-REFERENCE TO RELATED APPLICATIONS

This application claims the benefit of U.S. Provisional Application No. 63/161,901, filed on Mar. 16, 2021.

### TECHNICAL FIELD

The disclosure relates generally to systems and methods for processing waste, and more particularly, to production of plastic feedstock and fuels by pyrolysis of materials.

### BACKGROUND

Pyrolysis refers to the high-temperature thermal decomposition of substances. It may be important for improving availability of certain resources, reducing greenhouse gas (GHG) emissions to meet climate targets, and preventing plastic and biomass pollution. For example, pure methane (CH₄) can be decomposed into gaseous hydrogen (H₂) and solid carbon (C_{X} or “carbon black”) when subjected to temperatures above 1500-1700° C.

Similarly, plastics and biomass can be pyrolyzed into smaller chain molecules with industrial applications, e.g. ethane and methane.

Currently, recycling of plastics may be costly and may now allow generation of virgin or new plastics, e.g. the chemical structure of the plastics remains the same after recycling as per the current generation of recycling methods. For example, in some cases, safety concerns prevent the use of post-consumer recycled (PCR) materials for food containers since contaminants from the PCR material may appear in food containers made of PCR materials. Virgin plastics are typically produced use fresh hydrocarbons, e.g. as extracted from fossil resources, in processes that call for large energy inputs. As a result of these factors, virgin plastics have an inordinate impact on the environment and greenhouse gas emissions.

Pyrolysis can consume a significant amount of energy because of the high temperatures that materials need to reach for cracking. In some cases, pyrolysis may be part of a larger industrial process consuming material and energy. Pyrolysis temperatures may vary depending on the substances being pyrolyzed and the prevalent thermodynamic conditions, and may be reduced by means of catalysts. In some examples, pyrolysis processes have included burning fossil fuels for achieving desired thermodynamic conditions.

Pyrolysis may result in solid, liquid, and/or gaseous products, which may be compositions of (multiple types of) compounds. Control of pyrolysis conditions may provide control over products formed and their physical form, e.g. it has been suggested that high-value products like carbon nanotubes may be formed by controlling conditions during pyrolysis of methane.

Improvement in pyrolysis devices, systems, and processes is desired.

### SUMMARY

Societal pressure to address climate change is projected to lead to extensive regulation of industry and penalization of activities deemed environmentally harmful, e.g. carbon pricing may be used to disincentivize CO₂ emissions, and industry and product-specific regulations may limit the use and production of plastic to address plastic pollution, especially in the oceans, and for reducing industrial waste. Alternatives to fossil fuels and methods for reprocessing non-biodegradable waste (included mixed waste that may be partially non-biodegradable) are needed to ensure the long-term sustainability of communities and industries around the world.

Pyrolysis and industrial processes incorporating pyrolysis are promising avenues for reducing the environmental impacts of industry, for producing clean fuels, and for producing virgin plastics using post-consumer plastics (waste plastics). For example, pyrolysis may be used to crack post-consumer plastics into so-called “plastic crude”, which may be used instead of crude oil derived hydrocarbons to produce virgin plastics, and may also be used to generate hydrogen from natural gas without generating gaseous CO₂.

Pyrolysis may be used to convert waste plastic into useful products such as methane, ethane, and hexane. In many cases where recycling may be difficult and/or expensive, plastics may be exported to poor countries, and may eventually be discarded into lakes, rivers, oceans, and ecologically sensitive areas. Pyrolyzing waste plastic may enable production of useful end-products, such as plastic crude for production of virgin plastics, and renewable natural gas (RNG).

Prior to recycling and pyrolysis, waste plastic may be sorted. Mechanical sorting of waste plastic destined for landfill is very expensive and capital intensive. Over 80% of waste plastics produced in the world end up in landfills or in the environment (oceans and rivers) where they are mixed in with the other wasted materials. Selective or fractional pyrolysis may allow extraction of particular chemical compounds without requiring pre-sorting of waste materials used as input for the pyrolysis.

Current approaches to H₂ production may hamper adoption of H₂ as a clean alternative to fossil fuels because they may generate CO₂ as a by-product, e.g. steam methane reforming (SMR). Significant resources have been devoted to finding ways to capture and sequester the by-product CO₂ despite the challenging nature of such a task. Pyrolysis of methane may be used to generate hydrogen with the only by-product being solid carbon black, which itself has a variety of industrial uses and may be of considerably high value.

A multi-stage modular pyrolysis system that may facilitate high-temperature, energy-efficient, cost-effective, and/or well-controlled pyrolysis is disclosed herein. The pyrolysis system comprises a pyrolysis section surrounded by a heating chamber. The pyrolysis section comprises a chamber containing a screw conveyer (or screw conveyer chamber) for transporting therethrough materials to be pyrolyzed, pyrolysis products, and/or catalysts. The heating chamber receives hot gases produced by industrial processes to heat the pyrolysis section. For example, hot gases may include flue gases. The heating chamber may include spatially distributed ports for drawing fuel and/or air (or other fluid) as jets into the heating chamber to control the temperature of the pyrolysis section. The hot gases received by the heating chamber may raise the temperature sufficiently high therein to ensure spontaneous combustion or autoignition, e.g. no ignition equipment may be needed. The pyrolysis section may include additional pyrolysis stages comprising tubular ducts configured to receive gases and/or intermediate pyrolysis products from the screw conveyer chamber. One or more catalysis chambers may form part of the pyrolysis section or may be disposed downstream thereof.

In some aspects, there are disclosed systems and methods for processing mixed waste streams. Pyrolysis systems may be connected sequentially and may be configured for selective pyrolysis to achieve effective thermal sorting or removal of one or more materials from product streams. It is conceived that potentially millions of tons of plastic in legacy landfills may be mined to obtain useful materials such as plastics, metals, and various gases.

It is known that pyrolysis processes may have significant energy requirements, e.g. due to inherent differences in bond energies between start and end products. The methane pyrolysis reaction CH₄→C (s)+2H₂ (g) may involve a net enthalpy change of +75 kJ. Pyrolysis may require energetically demanding conditions to proceed, such as significantly higher than ambient temperatures with possibly lower than ambient pressures for achieving appropriate activation conditions (and energies). Non-catalytic cracking of CH₄ may occur at above 1500° C. Pyrolysis of methane is an equilibrium reaction, and may begin to produce carbon and hydrogen around 300° C. and may go to completion around 1000° C. In some cases, catalysts may reduce this temperature to 1100-1300° C.

The relatively high energy consumption of pyrolysis may be an important consideration, particularly when a goal of pyrolysis is to reduce energy consumption, GHG emissions, and/or produce fuel. Waste heat from upstream processes may be used to reduce the high energy consumption. In some cases, such waste heat may not provide enough energy for pyrolysis, and may not be predictable or sufficiently controllable. In some prior art systems, augmenting with additional heating may incur an undesirably high-cost penalty, e.g. in the form of fuel costs and additional capital expenditure in equipment such as burners and igniters. In some prior art systems, burners may generate waste heat of their own, thereby reducing efficiency and environmental benefits of pyrolysis. Additional equipment may have an effect on mobility of pyrolysis systems, e.g. mobile pyrolysis units used to generate fuel from wood biomass at lumber sites.

The form, quantity, and quality of products formed from pyrolysis may depend on temperature, pressure, material density, residence time, presence of catalysts and other factors. Well-controlled pyrolysis conditions may be important for achieving desired products and predictable product distributions. For example, waste plastic in the form of polyethylene (C₂H₄)ₙ may be pyrolyzed into the hydrocarbons, by weight ratio, 10% C₃H₆, 30% 1-C₈H₁₆, 40% C₁₆H₃₂, and 20% C₂₈H₅₆. Varying factors relevant for pyrolysis may change the product distribution, generate additional or different products, and/or prevent generation of certain products. Once formed, pyrolysis products may be separated into separate species or compositions.

In some cases, progressively higher or variable temperatures (and/or variation of other factors) may be needed to generate a cascade of products. For example, polyethylene may be decomposed into smaller hydrocarbons, some of which may then be cracked to generate gaseous hydrogen and carbon black. In some cases, continuous control over temperature may be used to achieve desired products.

In some prior art systems, lack of good control over the spatial distribution of temperature and other pyrolysis factors may lead to incomplete or undesirable pyrolysis. For example, if heating in a complex geometry pyrolysis chamber is provided via a localized source, “cold spots” may form therein. Cold spots may lead to incomplete pyrolysis. Well-controlled conditions may be needed to generate high quality pyrolysis products.

In addition to control of thermodynamic conditions, control of internal compositions in pyrolysis systems may be necessary. Pyrolysis chambers may be hermetically sealed to prevent oxidation and undesirable chemical reactions. For example, thermodynamic conditions inside pyrolysis chambers may provide potent conditions for oxidation if oxygen is allowed to leak thereinto.

Catalysts may be used to make pyrolysis conditions less demanding. Catalysts may operate in certain temperature ranges. Introducing catalysts into the pyrolysis process in a sustainable and cost-effective manner may be challenging, especially in the case of progressive or variable temperature pyrolysis chambers.

In practice, a pyrolysis system may be used as part of a mobile unit and may preferably be adaptable to process a variety of materials. For example, cost-effective, scalable, and easily deployable pyrolysis systems may be desirable.

In an aspect, the disclosure describes a pyrolysis system configured to receive material for pyrolysis. The pyrolysis system also includes a heating chamber configured to receive hot gas. The pyrolysis system also includes one or more ports for metering fuel and oxidizer to the heating chamber for combustion in the heating chamber. The pyrolysis system also includes a pyrolysis chamber for holding the material during pyrolysis in isolation from the hot gas in the heating chamber, the pyrolysis chamber disposed inside the heating chamber to circumferentially heat the material in the pyrolysis chamber and configured to convey the material through the pyrolysis chamber.

In an aspect, the disclosure describes a module for a pyrolysis system configured to receive material for pyrolysis. The module also includes a heating chamber section configured to receive hot gas. The module also includes one or more ports configured to meter fuel and oxidizer to the heating chamber section. The module also includes a pyrolysis chamber section configured to hold the material during pyrolysis in isolation from the hot gas, the pyrolysis chamber section disposed inside the heating chamber section to circumferentially heat the material in the pyrolysis chamber.

In an aspect, the disclosure describes a method for pyrolyzing material. The method also includes conveying the material through a pyrolysis chamber disposed inside of and fluidly isolated from a heating chamber. The method also includes heating the material in the pyrolysis chamber circumferentially by introducing hot gas into the heating chamber around the pyrolysis chamber. The method also includes combusting fuel in the heating chamber to heat the material to cause pyrolysis of the material.

In an aspect, the disclosure describes a method of processing a mixed waste stream including a first material and a second material. The method also includes generating a first group of pyrolysis products by pyrolyzing the mixed waste stream under conditions configured to cause pyrolysis of the first material and hinder pyrolysis of the second material. The method also includes separating out the first group of pyrolysis products to generate a residual waste stream including the second material. The method also includes generating a second group of pyrolysis products by pyrolyzing the residual waste stream under conditions configured to cause pyrolysis of the second material.

In an aspect, the disclosure describes a system for processing a mixed waste stream including a first material and a second material. The system also includes a first pyrolysis chamber configured to receive the mixed waste stream and heat to generate a first group of pyrolysis products by pyrolyzing the mixed waste stream under conditions configured to cause pyrolysis of the first material and hinder pyrolysis of the second material. The system also includes a second pyrolysis chamber, separate from the first pyrolysis chamber, the second pyrolysis chamber configured to receive heat and a residual waste stream to generate a second group of pyrolysis products by pyrolyzing the residual waste stream under conditions configured to cause pyrolysis of the second material, the residual waste stream being received via the first pyrolysis chamber by separating out the first group of pyrolysis products after pyrolysis of the first material of the mixed waste stream.

In an aspect, the disclosure describes a method of generating power using wet biomass. The method of generating power also includes combusting a fuel generated by pyrolysis of dried biomass to generate heat and first waste gas, the dried biomass and second waste gas being generated by drying of wet biomass, the first waste gas and second waste gas being used for drying of wet biomass. The method of generating power also includes using the heat to generate power.

In an aspect, the disclosure describes a pyrolysis system configured to receive material for pyrolysis. The pyrolysis system also includes a pyrolysis chamber for holding the material during pyrolysis of the material, a solid mass of the material in the pyrolysis chamber being varied due to pyrolysis. The pyrolysis system also includes a screw conveyer disposed inside the pyrolysis chamber and receiving the material to convey the material along the pyrolysis chamber as it is pyrolyzed in the pyrolysis chamber, the screw conveyer including a flight configured to compact the material based on the solid mass of the material during pyrolysis to facilitate pyrolysis.

In an aspect, the disclosure describes a method for pyrolyzing material. The method also includes heating the material in a pyrolysis chamber to pyrolyze the material to vary solid mass of the material. The method also includes compacting the material in the pyrolysis chamber to facilitate pyrolysis as the solid mass of the material is varied due to pyrolysis. Embodiments can include combinations of the above features.

Further details of these and other aspects of the subject matter of this application will be apparent from the detailed description included below and the drawings.

### DESCRIPTION OF THE DRAWINGS

A three or more stage pyrolysis plant is described for pyrolyzing materials travelling through the system, with particulate removal in-between processes. Gas production (e.g. renewable natural gas or RNG generated from waste materials) along travel (longitudinal direction) achieved by main screw conveyer system forming part of a pyrolysis chamber. After production, the gas may be cleaned via a high-temperature temp cyclonic particle removal. The gas is cleaned at temperature and then further processed. Temperature-controlled pyrolysis and catalytic cracking may be achieved in the pyrolysis chamber and a final catalytic cracking or reforming may be provided.

In some cases, the pyrolysis plant may have multiple pyrolysis chambers (or systems) coupled in series to achieve multi-stage pyrolysis or cracking. For example, two pyrolysis systems may define a primary cracker and a secondary cracker for cracking compounds into useful products. As another example, sorting of gaseous, liquid, and solid materials may be achieved via multiple pyrolysis systems to improve value of produced products. This is particularly relevant for mixed waste streams, since such non-molecularly homogenous materials may otherwise require expensive sorting before further processing.

The pyrolysis plant, in some embodiments, may facilitate tight control RNG makeup via temperature controls, two-stage cracking, catalytic cracking or reforming, removal of molecules, and addition of molecules (carbon monoxide or water injection to facilitate a water gas shift) to achieve targeted pyrolysis.

For example, water and small amounts of oxygen may be added at strategic locations down a longitudinal axis of the primary cracker and/or the secondary cracker to produce carbon monoxide and then, via the water gas shift reaction, to hydrogen and carbon dioxide, to enhance production of hydrogen.

In some cases, pyrolysis of natural gas/methane (or co-pyrolysis of natural gas with a waste stream such as mixed waste stream) may be efficiently achieved by a recirculating bio-char or carbon black as a lattice or carrier in the pyrolysis chamber. The recirculated carbon may provide a large surface area and thermal mass resulting in a highly effective thermal energy transfer mechanism whereby natural gas/methane can undergo cracking/reformation to hydrogen, solid carbon, and other intermediates. For example, this is particularly important for environmentally friendly production of hydrogen fuel.

In various embodiments, temperature over 1000° C. or between 300° C. and 1000° C. may be maintained in a final section of a primary cracker and as desired in secondary cracker and catalyzer to separate carbon and hydrogen from natural gas/methane.

The screw conveyer system used for conveying materials through the pyrolysis chamber may facilitate mixing/agitation, e.g. via pitch change and utilizations of paddles. The screw mechanism described may be allow managing of volume changes as the material is heated by reducing pitch to thereby reducing gaps/voids/open space in the materials as the materials loses volume, effectively enhancing surface contact and thereby conductive heat transfer. Pitch change may also enhance residence time due via pitch change down longitudinal length. Variations in paddle designs may allow agitation of materials as they move into different states of the material as they are pyrolyzed.

Reference is now made to the accompanying drawings, in which:

FIG. 1 is an isometric view of a pyrolysis system;

FIG. 2A is a front elevation view of the pyrolysis system;

FIG. 2B is a side elevation view of the pyrolysis system;

FIG. 3 is an isometric view of a pyrolysis chamber of the pyrolysis system, as shown by removing an outer body at least partially defining a heating chamber of the pyrolysis system;

FIG. 4 is a cross-sectional view of the pyrolysis system along 4-4 in FIG. 2A;

FIG. 5 is a cross-sectional view of the pyrolysis system along 5-5 in FIG. 2A;

FIG. 6 is a cross-sectional view of the pyrolysis system along 6-6 in FIG. 2B;

FIG. 7 is a schematic flow diagram of a process, in accordance with an embodiment;

FIG. 8 is a schematic flow diagram of a process for processing a mixed waste stream, in accordance with a further embodiment;

FIG. 9 is a schematic diagram of the controller for a pyrolysis system, in accordance with an embodiment;

FIG. 10 is an exemplary enthalpy diagram for methane pyrolysis to generate hydrogen; and

FIG. 11 is an isometric view of a screw (or auger) of a screw conveyer, in accordance with an embodiment; and

FIG. 12A is a front elevation view of the screw, in accordance with an embodiment;

FIG. 12B is a side elevation view of the screw, in accordance with an embodiment;

FIG. 13 is a flow chart of a method of pyrolyzing material, in accordance with an embodiment;

FIG. 14 is a flow chart of a method processing a mixed waste stream including a first material and a second material, in accordance with an embodiment;

FIG. 15 is a flow chart of a method of generating power using wet biomass, in accordance with an embodiment;

FIG. 16 is a flow chart of a method of pyrolyzing material, in accordance with an embodiment;

FIG. 17A is a partial isometric view of a pyrolysis chamber of a pyrolysis system, as shown by removing an outer body at least partially defining a heating chamber of the pyrolysis system, in accordance with an embodiment; and

FIG. 17B is an enlarged isometric view of region 17B in FIG. 17A.

### DETAILED DESCRIPTION

The following disclosure relates to pyrolysis methods, systems, and processes. In some embodiments, the assemblies and methods disclosed herein may facilitate high-temperature pyrolysis, including above 1200-1500° C., reduction of wasted energy in industrial processes, sorting of mixed waste streams, and cost-effective pyrolysis compared to existing assemblies and methods.

Aspects of various embodiments are described in relation to the figures.

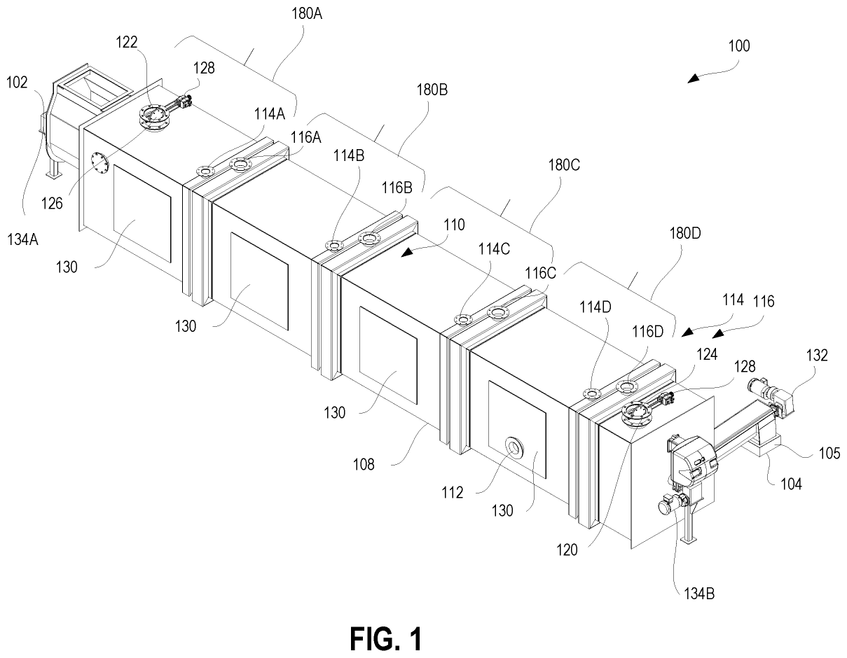

FIG. 1 is an isometric view of a pyrolysis system 100.

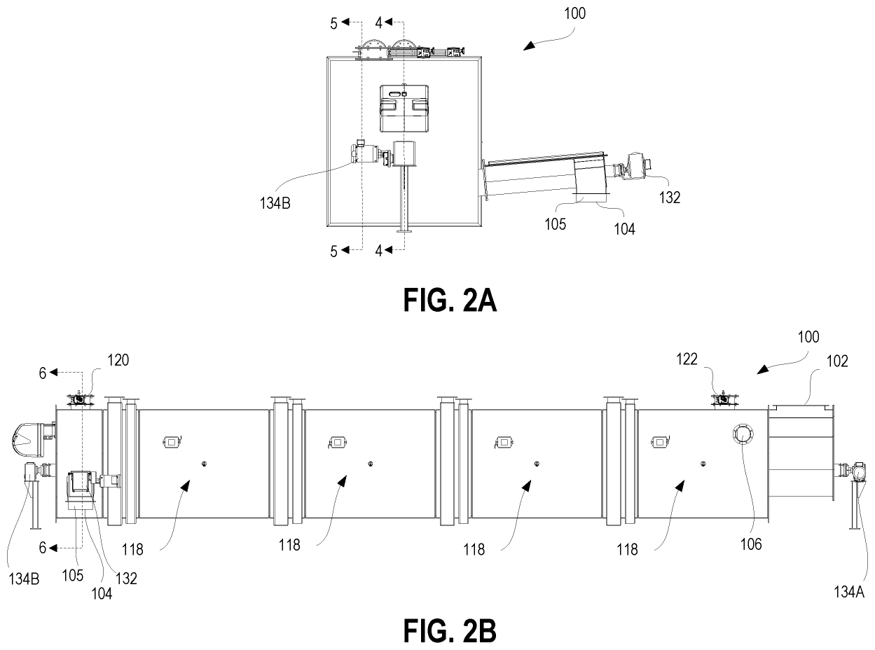

FIG. 2A is a front elevation view of the pyrolysis system 100.

FIG. 2B is a side elevation view of the pyrolysis system 100.

The pyrolysis system 100 may be configured to receive material therein for pyrolysis. The pyrolysis system 100 may include one or more pyrolizer sections or pyrolizers.

The pyrolysis system 100 may be a modular pyrolysis system comprising one or more modules (modules 180A, 180B, 180C, 180D) that may be connected in sequence to form the pyrolysis system 100.

The material may be received via a material inlet 102.

In various embodiments, the materials may include biosolids, dried biomass, wet biomass, plastics, methane, ethane and/or other hydrocarbons. The material may be a single component or a multicomponent mixture. In various embodiments, the material may be single or multiphase and may include solid, liquid, and/or gaseous substances. For example, in some embodiments, the material may be a mixed waste stream such as a mixture of plastics and organic material. In some embodiments, catalysts or materials to improve or control pyrolysis may be fed in or mixed in with a mixed waste stream, or separately supplied to the material inlet 102. For example, carbon black, ash, char, and/or other materials may be fed, mixed in or supplied.

Pyrolysis processes in the pyrolysis system 100 may generate products from the material. Products may be released from a first material outlet 104 or a material outlet 106.

The first material outlet 104 may be especially adapted for releasing solid products, e.g. the first material outlet 104 may be equipped with one or more conveyers to facilitate movement of solidified mass out of the pyrolysis system 100. An airlock 105 may be coupled to the first material outlet 104 to prevent entering the pyrolysis system. For example, in various systems, airlocks may include knife airlocks, ram or gate airlocks, and/or rotary airlocks.

The second material outlet 106 may be adapted to release fluid products, e.g. gaseous products. In various embodiments, the second material outlet 106 may be airlocked to prevent air from entering therein.

As discussed later, in some embodiments, the material may be pyrolyzed to generate intermediate products and solid products. In some embodiments, the solid products may be released via the first material outlet 104. In some embodiments, the intermediate products may undergo one or more additional stages of pyrolysis to generate the fluid products released from the second material outlet 106.

In various embodiments, the first material outlet 104 and second material outlet 106 may be sealed against gases entering the pyrolysis system 100 to hinder pyrolysis.

The pyrolysis system 100 may carry out multiple pyrolysis stages. Compounds generated from one pyrolysis process to be used in a subsequent pyrolysis process may be referred to as intermediate products.

In some cases, the material is a multicomponent mixture, wherein some components undergo pyrolysis while others do not. Unless indicated otherwise, the resulting mixtures may be referred to as products herein.

The pyrolysis system 100 may define a heating chamber 108. For example, in some embodiments, an outer body 110 of the pyrolysis system 100 may define the heating chamber 108. In some embodiments, insulation may be provided to prevent heat escaping from the heating chamber 108. For example, the insulation may be disposed over the outer body 110 and/or may form an additional structure external to and covering the outer body 110.

The heating chamber 108 may contain enclosed spaces for pyrolysis, e.g. one or more pyrolysis chambers and tubular ducts. In some embodiments, the heating chamber 108 may be an oxidizer chamber nesting a pyrolysis chamber.

The heating chamber 108 may be configured to receive hot gas via a hot gas inlet 112 of the pyrolysis system 100. The hot gas may carry waste heat, e.g. from an industrial process that is upstream of the heating chamber 108.

In some embodiments, the hot gas may carry a first portion of heat generated for use in an industrial process that is upstream of the heating chamber 108 and a second portion of the heat may be consumed in the industrial process itself. In various embodiments, the hot gas may be a product of combustion used to generate heat for the industrial process.

As referred to herein, an industrial process that is upstream may refer to any process, separate from downstream pyrolysis, that is industrially useful and requires energy inputs. For example, in various embodiments, the industrial process may be or may include power generation (using chemical energy input for generating electrical or shaft power output, metal refining, polymer processing, or other industrial process requiring energy inputs.

The pyrolysis system 100 may include one or more ports 114A-114D, 116A-116D metering fuel and oxidizer to the heating chamber 108 for combustion in the heating chamber 108. The one or more ports may include a plurality of fuel ports 114 (including fuel ports 114A, 114B, 114C, 114D) and a plurality of oxidizer ports 116 (including oxidizer ports 116A, 116B, 116C, 116D). In some embodiments, each module 180A-D of the pyrolysis system 100 may include a respective fuel port 114A-D and a respective oxidizer port 116A-D. For example, a fuel port and an oxidizer port may be integrated with a brace ring of a module.

In some embodiments, the plurality of fuel ports 114 and plurality of oxidizer ports 116 may be sealed to prevent leakage of fluids into the heating chamber 108. For example, the heating chamber 108 may be sealed against intrusion of nitrogen therein to prevent generation of harmful NOₓ products.

Combustion in the heating chamber 108, and injection of cooling fluid, may be used to trim or control temperature in the pyrolysis system 100. In some embodiments, the hot gases entering the heating chamber 108 may not carry sufficient heat to sustain pyrolysis, or may carry excess heat.

In various embodiments, the pyrolysis system 100 may include sensors 118 for measuring temperature in the heating chamber 108 (e.g. thermocouples). In some embodiments, each module 180A-D may have at least one dedicated temperature sensor or speed sensor (e.g. a hot-wire anemometer). In some embodiments, each module 180A-D may have at least one pressure sensor.

In some embodiments, a venting port 120 may be provided to controllably or selectively vent or release gases from the pyrolysis chamber, e.g. after pyrolysis process have ended or during shut-down of the pyrolysis system 100. In some embodiments, the venting port 120 may be a safety valve. For example, in some cases, the venting port 120 may remain substantially shut during operation of the pyrolysis system 100. For example, the venting port 120 may be disposed proximal to the first material outlet 104.

In various embodiments, venting via the venting port 120 may be continuous during or after shut-down of the pyrolysis system 100. Venting may be avoided to reduce the risk of ambient air intruding into the pyrolysis system 100 during pyrolysis processes. In some embodiments, gases released may be from pyrolysis products generated, and outgassing from pyrolysis products. A composition of gases proximal to the venting port 120 may be monitored via the venting port 120.

An exhaust port 122 may be configured to exhaust gases from the heating chamber 108 after they have performed a desired heat transfer function. In some embodiments, during continual operation, heating chamber 108 gases may be continually exhausted.

In various embodiments, the venting port 120 and the exhaust port 122 may be disposed at opposed ends of the pyrolysis system 100. In some embodiments, the venting port 120 may be disposed proximal to the first material outlet 104 relative to the exhaust port 122. In some embodiments, the exhaust port 122 may be disposed proximal to the second material outlet 106 relative to the venting port 120. In some embodiments, the venting port 120 and the exhaust port 122 may be disposed at longitudinal ends of the pyrolysis system 100. For example, the longitudinal ends may be opposed ends defined by the first material outlet 104 and the second material outlet 106.

In various embodiments, the venting port 120 and/or the exhaust port 122 may be configured with valves to control flow therethrough. For example, a venting gate valve 124 may be configured to controllably vent gas from the pyrolysis chamber via the venting port 120. For example, an exhaust gate valve 126 may be configured to controllably exhaust gas from the heating chamber 108.

In various embodiments, sensors 128 (such as temperature probes) may be disposed in the venting port 120 and/or exhaust port 122 for measuring composition and other properties of fluid moving through or proximal to the respective ports. In some embodiments, the venting port 120 and/or the exhaust port 122 may be at least partially controllable based on measurements obtained from the sensors. For example, the venting port 120 and/or the exhaust port 122 maybe controllable via a controller configured to receive sensor measurements.

In some embodiments, the pyrolysis system 100 may comprise one or more removable panels 130. The removable panels may allow access to the heating chamber 108. In some embodiments, the removable panels 130 may be replaced with panels having features interfacing with the heating chamber interior, e.g. one or more removable panels 130 may have ports configured to connect to hot gas sources.

In some embodiments, the pyrolysis system 100 may include an electric motor 132 to power an exit conveyer. In some embodiments, the pyrolysis system 100 may include electric motors 134A, 134B disposed at opposed ends of the pyrolysis system 100 for rotatably driving a common conveyer shaft. The electric motors 134A, 134B may be anchored to the ground via anchoring points.

At higher temperatures, above 1500° C. as may be used in high-temperature pyrolysis, structural materials such as steel may soften, which may lead to increased warping of rotating shafts due to torsional loading. Providing independent rotational driving along a plurality of locations along the shaft may reduce warping and probability of structural failure, e.g. by rotatably driving the shaft at opposed ends.

High-temperature pyrolysis may be beneficial for encouraging complete pyrolysis. Table 1 shows product yield weight ratios at different temperatures, from pyrolysis of an equal mixture of polyethylene, polypropylene, and polystyrene. As temperature increases, the relative proportion of intermediate products (wax and oil) decreases, and the relative proportion of gas products increases.

TABLE 1

| Temperature (° C.) | Gas | Wax and oil | Residual |
|---|---|---|---|
| 650 | 0.17 | 0.80 | 0.3 |
| 685 | 0.60 | 0.33 | 0.7 |
| 730 | 0.79 | 0.19 | 0.2 |
| 780 | 0.79 | 0.15 | 0.6 |
| 850 | 0.75 | 0.11 | 0.14 |

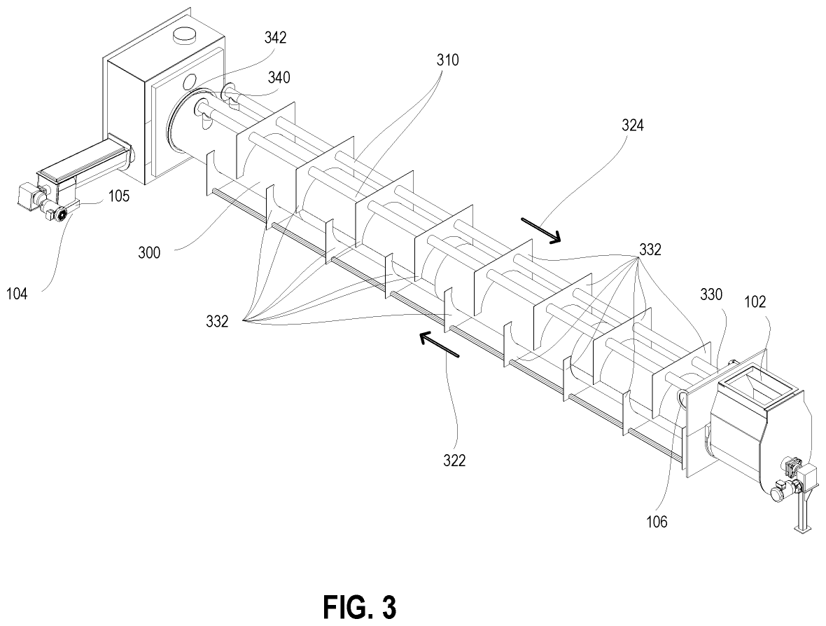

FIG. 3 is an isometric view of a pyrolysis chamber 300 of the pyrolysis system 100, as shown by removing the outer body 110 of the pyrolysis system 100 at least partially defining the heating chamber 108.

The pyrolysis chamber 300 may be disposed inside the heating chamber 108 to receive heat therefrom and circumferentially heat the material therein. One or more tubular ducts 310 (hereinafter referred to as tubular ducts 310) may also be disposed inside the heating chamber 108 and may be connected to the pyrolysis chamber 300. In some embodiments the tubular ducts 310 may include at least two ducts. Pyrolysis process may occur in the tubular ducts 310. Tubular ducts 310 may also be referred to as cracking tubes.

The pyrolysis chamber 300 may be configured to hold the material received by the pyrolysis system 100 during pyrolysis. In some embodiments, the pyrolysis chamber 300 may hold the material for a portion of duration of pyrolysis or during a first stage of pyrolysis.

The tubular ducts 310 may also be configured as an enclosure for carrying out pyrolysis reactions. In various embodiments, the tubular ducts 310 may receive the material, products, and/or intermediate products from the pyrolysis chamber 300.

The pyrolysis chamber 300 and tubular ducts 310 may be configured to isolate substances therein to prevent reactions hindering or competing with pyrolysis, such as oxidative reactions and combustion. For example, the material in the pyrolysis chamber 300 may be held in isolation from hot gases in the heating chamber 108 since the hot gases in heating chamber 108 may include fuel, oxidizer, waste gas, and/or combustion products. The pyrolysis chamber 300 and tubular ducts 310 may be secured against leaks. The pyrolysis chamber 300 may operate at a lower than ambient pressure. Flow from the ambient into the pyrolysis chamber 300 may be prevented by airlocks and seals.

In various embodiments, material flow, including flow of products, intermediate products, and the material received in the pyrolysis system 100, may be oriented longitudinally along the pyrolysis system 100. For example, the material flow in the pyrolysis chamber 300 may be directed along a first longitudinal direction 322 from the material inlet 102 towards the first material outlet 104, and the material flow in the tubular ducts 310 may be directed along a second longitudinal direction 324 opposed the first direction. The second longitudinal direction 324 may be oriented from the first material outlet 104 towards the second material outlet 106. A reversal of the material flow direction from pyrolysis chamber 300 to the tubular ducts 310 may facilitate a relatively compact configuration for pyrolysis.

In various embodiments, the tubular ducts 310 may be disposed above the pyrolysis chamber 300 to preferentially receive lighter substances from the pyrolysis chamber 300. For example, the tubular ducts 310 may selectively receive lighter fluid products rising in the pyrolysis chamber 300 relative to other, heavier, substances therein. In some embodiments, only fluids may be received in the tubular ducts 310. In some embodiments, only solid material may remain in the pyrolysis chamber 300 downstream of the connection of the tubular duct(s) to pyrolysis chamber 300.

In some embodiments, the tubular ducts 310 may include two or more tubular ducts 310 of smaller cross-sectional area than the pyrolysis chamber 300. A resulting surface area of the tubular ducts 310 may be greater than the surface area of a single tubular duct 310 configured to carry intermediate products. Greater surface areas may facilitate greater heat exchange between the heating chamber 108 and substances inside the tubular ducts 310.

A configuration of the tubular ducts 310 may be configured to achieve a desired heat exchange function. For example, the number, shape, and size(s) of tubular ducts 310 may be varied to modify heat exchange function for obtaining target pyrolysis products, e.g. those products emerging from the second material outlet 106. In some embodiments, the tubular ducts 310 may include a sequential arrangement and configuration of tubular ducts 310 configured to stage pyrolysis processes. For example, in some embodiments, the number and size of tubular ducts 310 may be varied in sequence from the pyrolysis chamber 300 to the second material outlet 106.

In some embodiments, a catalysis chamber 330 may be disposed inside the heating chamber 108. The catalysis chamber 330 may be fluidly connected to the pyrolysis chamber 300. The catalysis chamber 330 may include one or more catalysts to catalyze pyrolysis reactions and facilitating pyrolysis. The catalysts may be heated by the heating chamber 108 for facilitating pyrolysis. In some embodiments, the catalysis chamber 330 may be disposed at a downstream end of the tubular ducts 310. A downstream end of the tubular ducts 310 may be connected to the catalysis chamber 330. Two or more of the tubular ducts 310 may be connected to the catalysis chamber 330. The catalysis chamber 330 may be connected to the second material outlet 106 to release products therefrom after catalyzing them.

In some embodiments, the catalysis chamber 330 may include reactants to eliminate harmful or toxic gases. For example, when the material entering the pyrolysis system 100 includes waste plastic, the catalysis chamber 330 may include NKC-5 to catalyze and enhance pyrolysis reactions producing non-condensable gases from an exit stream emanating from the second material outlet 106. Example product distributions (in terms of weight percentage) achieved using different catalysts is illustrated in Table 2.

TABLE 2

| Catalyst | Gas | Liquid |
|---|---|---|
| No catalyst | 17% | 83% |
| NKC-7 | 25% | 75% |
| NKC-5 | 58% | 42% |
| NKC-3A | 24% | 76% |

In some embodiments, the pyrolysis chamber 300 may include catalysts disposed therein. The pyrolysis chamber 300 may be a catalyst reservoir. In some embodiments, pyrolysis products may be used as catalysts. For example, in the case of the methane pyrolysis, the material may comprise natural gas and the catalyst may be carbon black.

In some embodiments, the pyrolysis chamber 300 may be filled with carbon black, soot, ash, char, or other forms of carbon. Carbon may catalyze pyrolysis reactions, provide thermal inertia to maintain temperatures inside the pyrolysis chamber 300, and encourage substantially uniform or uniformly varying distributions of temperature, e.g. cold spots may be mitigated. Additional carbon black produced by the pyrolysis process may be released into the catalyst reservoir and excess catalyst may be conveyed out of the pyrolysis system 100 via the first material outlet 104. In some embodiments, the pyrolysis chamber 300 may be fully filled with carbon black generated as products from pyrolysis processes.

Example carbon catalysts include carbon black such as Vulcan® XC72 or Black Pearls® 2000, carbon nanotubes or multi-walled nanotubes, and mesoporous or microporous activated carbon

In some embodiments, the pyrolysis chamber 300 may be filled with other types of catalysts, materials to increase thermal inertia, and/or materials to encourage substantially uniform or uniformly varying distributions of temperature.

One or more (or a plurality of) baffles 332 (hereinafter referred to as baffles 332) may be disposed in the heating chamber 108 to guide fluid therein. In some embodiments, at least two baffles may be disposed in the heating chamber 108. In some embodiments, the baffles 332 may be staggered along a longitudinal direction of the pyrolysis chamber 300 associated with progression of pyrolysis (e.g. see longitudinal directions 322, 324). A staggered configuration may hinder fluids in the heating chamber 108 from flowing only on one side of the pyrolysis chamber 300 and to encourage flow of fluids on opposing sides of the pyrolysis chamber 300 (or uniform heating of the pyrolysis chamber 300). In some embodiments, the baffles 332 may prolong residence time of fluids in the heating chamber 108 to increase heat transfer to the pyrolysis chamber 300 and the material therein. The residence time may be prolonged by increasing the effective length of flow in the heating chamber 108 or providing increased flow resistance. In some embodiments, the baffles 332 may facilitate a zig-zag flow of fluid through the heating chamber 108. Such a zig-zag flow may improve heat distribution and reduce cold spots in the pyrolysis chamber 300, and may also encourage turbulence in the heating chamber 108 to increase heat transfer rates. In various embodiments, zig-zag flow may general refer to flow exhibiting one or a series of sharp turns, including in alternating directions.

The baffles 332 may be adapted to fit the pyrolysis chamber 300 and the tubular ducts 310. For example, in some embodiments, the baffles 332 may be conformal to an outer surface of the pyrolysis chamber 300. In various embodiments, slots or holes formed in the baffles 332 may be adapted to and receive the tubular ducts 310 and/or beams extending longitudinally along the pyrolysis chamber 300 to support the baffles 332 inside the heating chamber 108. Such a configuration may allow for a compact and cost-effective pyrolysis system 100. For example, the tubular ducts 310 may support the baffles 332 and facilitate pyrolysis.

In some embodiments, the pyrolysis chamber 300 may be configured for high-temperature pyrolysis. For example, in some embodiments, pyrolysis temperatures may exceed 1000° C. or 1500° C. High temperatures may lead to large expansion of components. For efficiency, heat may be retained within the pyrolysis chamber 300. Components adjacent to the pyrolysis chamber 300 and outside the heating chamber 108 may be relatively cooler. The pyrolysis chamber 300 may be connected to the first material outlet and/or the airlock 105 via a sliding seal 340. In various embodiments, the sliding seal 340 may allow sliding of a longitudinal end of the pyrolysis chamber 300 within a sleeve 342 while maintaining sealing to prevent intrusion of ambient air into the pyrolysis chamber 300. A temperature differential with components adjacent to the pyrolysis chamber 300 may lead to significant relative expansion, which may be accommodated by the sliding seal 340.

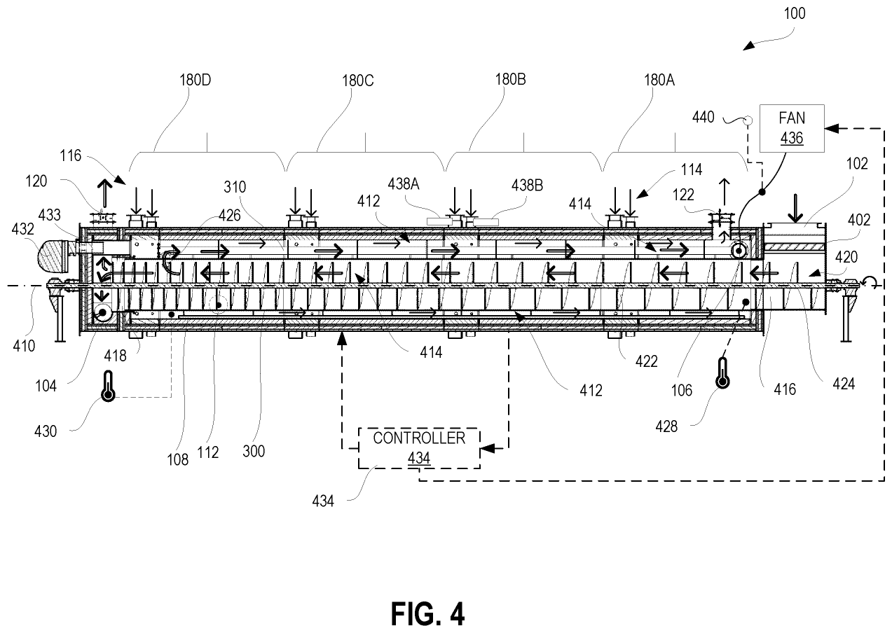

FIG. 4 is a cross-sectional view of the pyrolysis system 100 along 4-4 in FIG. 2A.

The pyrolysis system 100 may define a longitudinal axis 410, along which the pyrolysis chamber 300 may be centered. Example material paths 412 through the heating chamber 108 of the pyrolysis system 100 are indicated by thick arrows. Example material paths 414 through pyrolysis portions of the pyrolysis system 100, such as the pyrolysis chamber 300 and the tubular ducts 310, are indicated by hollow-bodied arrows.

The pyrolysis chamber 300 may have an inlet end 416 and an outlet end 418. In various embodiments, one or more conveyers may convey the material in the pyrolysis chamber 300 between the inlet end 416 and the outlet end 418.

The inlet end 416 may be configured to receive material from the material inlet 102. An airlock 402 may be coupled to the material inlet 102 to prevent intrusion of air into the pyrolysis chamber 300.

The outlet end 418 may be configured to release products through the first material outlet 104.

A screw conveyer 420 may be disposed inside the pyrolysis chamber 300 and may extend longitudinally between the inlet end 416 and the outlet end 418 thereof. The screw conveyer 420 may convey the material through the pyrolysis chamber 300 from the inlet end 416 towards the outlet end 418. In various embodiments, the screw conveyer 420 may be configured to mix, stir, and/or agitate the material through the pyrolysis chamber 300. For example, mixing may help achieve well-mixed reactions, uniform reactions, or faster reaction rates.

The screw conveyer 420 may include a screw 422 (or auger) defining a flight, blades and/or paddles coupled to a central shaft 424 to drive the screw 422 to convey the material. In some embodiments, the central shaft 424 of the screw conveyer 420 may be coupled to the (two) electric motors 134A, 134B to rotatably drive the central shaft 424 around the longitudinal axis 410. In some embodiments, the rotation rate of the central shaft 424 may be approximately 1 revolution per minute or less. The first electric motor 134A may be disposed at a first end of the central shaft 424 and the second electric motor 134B may be disposed at a second end of the central shaft 424 opposed the first end.

In some embodiments, the screw 422 (and/or a flight, blades, and/or paddles thereof) of the screw conveyer 420 may have varying pitch to compensate for changes to the material while it is moving through the pyrolysis chamber 300, e.g. loss of solid mass due to pyrolysis and heat-induced volume change. For example, blades proximal to the outlet end 418 of the pyrolysis chamber 300 may be relatively more closely spaced than blades proximal to the inlet end 416 of the pyrolysis chamber 300.

The pyrolysis chamber 300 may comprise one or more openings 426 at a downstream end thereof. The tubular ducts 310 may be fluidly connected to the downstream end of the pyrolysis chamber 300 via the one or more openings 426 to receive products therefrom and to hinder flow of solids through the tubular ducts 310. For example, in some embodiments, the pyrolysis chamber 300 may include at least two openings 426 to fluidly connect the tubular ducts 310 and the pyrolysis chamber 300.

The tubular ducts 310 may selectively receive intermediate products from the pyrolysis chamber 300. In various embodiments, the intermediate products may be gaseous. In some embodiments, the openings 426 may be disposed in the pyrolysis chamber 300 to preferentially receive lighter or more buoyant fluids (intermediate products) rising vertically due to gravity and to hinder flow of heavier materials, e.g. soot or other solids, into the openings 426. For example, the openings 426 may be disposed in a vertically higher or upper half of the pyrolysis chamber 300.

The products may flow in the tubular ducts 310 generally directed towards the second material outlet 106, which may be disposed above an upstream end of the pyrolysis chamber 300 to draw out at least a portion of pyrolysis products therefrom. The one or more tubular ducts 310 may pass through the heating chamber 108 to supply heating to the portion of pyrolysis products. In some embodiments, flow in the heating chamber 108 and the tubular ducts 310 may flow in a generally similar direction, away from the first material outlet 104.

After intermediate products are received in the tubular ducts 310, the remaining products (“residual products”) may be conveyed to the outlet end 418 of the pyrolysis chamber 300. The residual products may at least partially include some residual solids, such as carbon black generated from pyrolysis of methane, catalytic carbon (mixed with carbon black) overflowing from the pyrolysis chamber 300 after pyrolysis of methane, or waste metals with high melting points that are left relatively unchanged after pyrolysis of mixed waste streams.

At the outlet end 418, the residual products may be at least partially conveyed out of the pyrolysis system 100 via the first material outlet 104.

The pyrolysis chamber 300 and tubular ducts 310 are heated circumferentially or uniformly by the heating chamber 108. For example heating may be provided laterally all around the pyrolysis chamber 300.

The material paths 412 from the material inlet 102 to the first material outlet 104, and from the material inlet 102 to the second material outlet 106 via the openings 426 define substantially hermetically sealed passages. In some embodiments, the pressure inside the pyrolysis chamber 300 and tubular ducts 310 may be lower than the ambient pressure. In various embodiments, vacuum pumps and/or fans may maintain lower pressure inside the pyrolysis chamber 300 and the tubular ducts 310.

In some embodiments, a fan 436 may be fluidly connected to the pyrolysis chamber 300 to depressurize the pyrolysis chamber 300 to below atmospheric pressure. For example, in some embodiments, a pressure indicated by 30 inches of water below atmospheric pressure may be achieved.

In some cases, one or more fans may be used to depressurize the heating chamber 108 to below atmospheric pressure. In some embodiments, a pressure indicated by 10 inches of water below atmospheric pressure may be achieved in the heating chamber 108. Such fans may be connected to the controller 434 and may be configured to be actuated by the controller 434. For example, each oxidizer and fuel port may be provided with a respective fan disposed upstream thereof. In some cases, the hot gas inlet 112, venting port 120, and/or exhaust port 122 may be provided with respective fans disposed upstream thereof.

The heating chamber 108 receives hot gases from upstream processes via the hot gas inlet 112. The hot gas follows the baffles 332 around and along the pyrolysis chamber 300 and is then exhausted via the exhaust port 122. In some cases, a downstream process may use the exhausted gas.

In some embodiments, exhausting of gases may be stopped during start-up of the pyrolysis system 100 to achieve pyrolysis conditions. In some embodiments, exhausting of gases may be paused during operation to adjust conditions inside the pyrolysis chamber 300. For example, exhausting gases may be paused to vary the temperature sensed by a temperature sensor 428 in the pyrolysis chamber 300.

Fuel and oxidizer supplied to the heating chamber 108 may undergo combustion therein in the presence of hot gases, to provide additional heating and control heat provided to the pyrolysis chamber 300 and the tubular ducts 310.

The hot gas may increase the temperature in the heating chamber 108 (e.g. a temperature sensed by a temperature sensor 430) above an autoignition temperature of the fuel-oxidizer mixture inside the heating chamber 108. The fuel and oxidizer may spontaneously combust after being injected into the heating chamber 108, due to the relatively high temperatures. In various embodiments, no igniters or other combustion-initiating devices may be needed.

In some embodiments, a burner 432 may be disposed at a longitudinal end of the pyrolysis system 100 for facilitating starting of combustion in case spontaneous combustion does not takes place or does not occur sufficiently fast, e.g. by initiating a combustion reaction.

Fuel and oxidizer may be metered to the pyrolysis system 100 via the plurality of fuel ports 114 and the plurality oxidizer ports 116 to sustain an energetic environment for pyrolysis and to control pyrolysis processes. In various embodiments, a controller 434 may adjust fuel and oxidizer inputs based on measured temperature in the heating chamber 108. A ratio of fuel and oxidizer may be controlled to achieve target combustion in the heating chamber 108.

In some embodiments, the pyrolysis system 100 may include dilution ports or cooling ports, configured to introduce cooling fluid into the heating chamber 108. The temperature in the heating chamber 108 may be controlled, such as by an automatic control system or controller 434, by facilitating combustion using fuel and oxidizer (for heating) and by actuating cooling ports (for cooling). In some embodiments, an oxidizer port may also be a cooling port. For example, oxidizer may be cooler and may be used to lower the temperature in the heating chamber 108.

In various embodiments, one or more valves 438A, 438B may be connected to the heating chamber 108 and the controller 434. The valves 438A, 438B may be actuatable to meter at least one of the fuel or the oxidizer to the heating chamber 108 by the controller 434, which may be actuatably connected to the valves 438A, 438B. For example, the valves 438A, 438B may be electrically actuated gate valves that are configured to actuatably open and close fuel and/or oxidizer ports to vary a flow rate of fuel and oxidizer to the heating chamber. Metering of fuel and oxidizer may allow control of pyrolysis processes, e.g. formation of pyrolysis products, and the physical properties thereof. For example, the physical properties such as crystal structure of granular carbon black that is formed from pyrolysis may be controlled to some extent.

In various embodiments, a plurality of valves may be distributed longitudinally along the heating chamber 108 to achieve spatiotemporal control of heat input, and hence of temperature, of the heating chamber 108 by the controller 434. For example, while the valves 438A, 438B are shown at a single pair of fuel and oxidizer ports, one or more of the other pairs of fuel and oxidizer ports may be equipped with controllable valves.

Spatiotemporal control may refer to control in space and time. Control in space may include control along the longitudinal direction and circumferentially around the pyrolysis chamber 108. Spatiotemporal control of heat provided to the material in the pyrolysis chamber 300 may allow adjustment of pyrolysis process, e.g. adjustment of the stages of pyrolysis. In some embodiments, fine adjustments and/or tuning of such processes may be achieved.

In various embodiments, sensors may be provided for sensing a temperature for pyrolysis and a quantity indicative of pressure in the pyrolysis chamber 300. Such sensors may be connected and/or coupled to the controller 434. The controller 434 may control actuators and other components based on signals received from such sensors.

For example, a temperature for pyrolysis may be sensed using a temperature sensor 428 disposed in the pyrolysis chamber 300. In some embodiments, a temperature of pyrolysis may be sensed indirectly by inference, e.g. using a proxy quantity, such as a temperature in the heating chamber 108.

For example, a quantity indicative of pressure in the pyrolysis chamber 300 may be sensed by a pressure sensor 440 (or flow rate sensor) disposed upstream of the fan 436. In some embodiments, pressure sensor(s) may be disposed within the pyrolysis chamber 300, the tubular ducts 310, and/or conduits disposed outside of the heating chamber 108 and fluidly connecting the fan 436 to the pyrolysis chamber 300.

The temperature sensor 428 and the pressure sensor 440 may be connected to the controller 434.

In various embodiments, the controller 434, connected to the valves 438A, 438B, may be configured to actuate the valves 438A, 438B to control the fuel supplied to the heating chamber 108 based on the temperature sensed by the temperature sensor 428 to achieve a targeted pyrolysis of the material (to control pyrolysis based on feedback).

In various embodiments, the controller 434 may be connected to the fan 436 to actuate the fan 436 to control suction provided by the fan 436 to the pyrolysis chamber 300, based on the quantity sensed by the pressure sensor 440 to maintain the pressure in the pyrolysis chamber 300. Active control of the pressure may allow maintaining the pressure in the pyrolysis chamber 300 below atmospheric pressure, which may reduce requirements relating to sealing and prevention of air ingress.

In some embodiments, rotational transducers may be provided to measure a rotation rate of the central shaft 424. The rotational transducers may be connected to the controller 434. The controller 434 may be coupled to a motor driving the central shaft 424 to control a rotational speed thereof. In various embodiments, such a configuration is particularly advantageous as it may address challenges associated with inhomogeneous material being fed into the pyrolysis chamber 300, since such material may change the torque required to maintain a particular rotational speed (and hence speed of conveyance along the pyrolysis chamber 300).

In some embodiments, an energy or temperature of the waste heat may be difficult to predict. For example, the waste heat may cause the temperature in the heating chamber 108 to exceed or fall short of a desired temperature for pyrolysis.

A temperature of the hot gas entering the heating chamber 108 may be configured to enable autoignition of the fuel and the oxidizer inside the heating chamber 108. In some embodiments, the temperature of the hot gas may be above the autoignition temperature, which may lead to instantaneous combustion.

In some embodiments, the temperature of the hot gas may be sufficiently high to reach autoignition temperatures via heat transfer from reacting species in the heating chamber 108, such as fuel and oxidizer reactions. For example, a residence time of the hot gas in the heating chamber 108 may be configured to facilitate autoignition.

In some embodiments, the burner 432 may initiate combustion in the heating chamber 108. An outlet duct 433 of the burner 432 may be fluidly connected to the heating chamber 108. The burner 432 may not open to the pyrolysis chamber 300.

In various ports, fuel and oxidizer ports 114, 116 may define one or more longitudinally distributed sections of the pyrolysis chamber 300 and corresponding sections of the heating chamber 108. For example, each module 180A-D may correspond to a corresponding section of the pyrolysis chamber 300. The temperature in each section may be varied by controlling fuel and oxidizer flow through fuel and oxidizer ports of that section. Such temperature control may be used to stage pyrolysis and/or ensure efficient pyrolysis by progressively heating the material in the pyrolysis chamber 300. In some embodiments, the temperatures in one or more sections may be varied to achieve a desired temperature of catalysts.

In some embodiments, a temperature of catalysts in the catalysis chamber 330 may be decreased by injecting cooling air in a section of the heating chamber 108 upstream of the catalysis chamber 330, and similarly, may be increased by increasing fuel and oxidizer flow to the section. Temperature variation in sections of the heating chamber 108 further upstream may be prevented by facilitating more combustion therein or allowing more cooling fluid to flow therethrough.

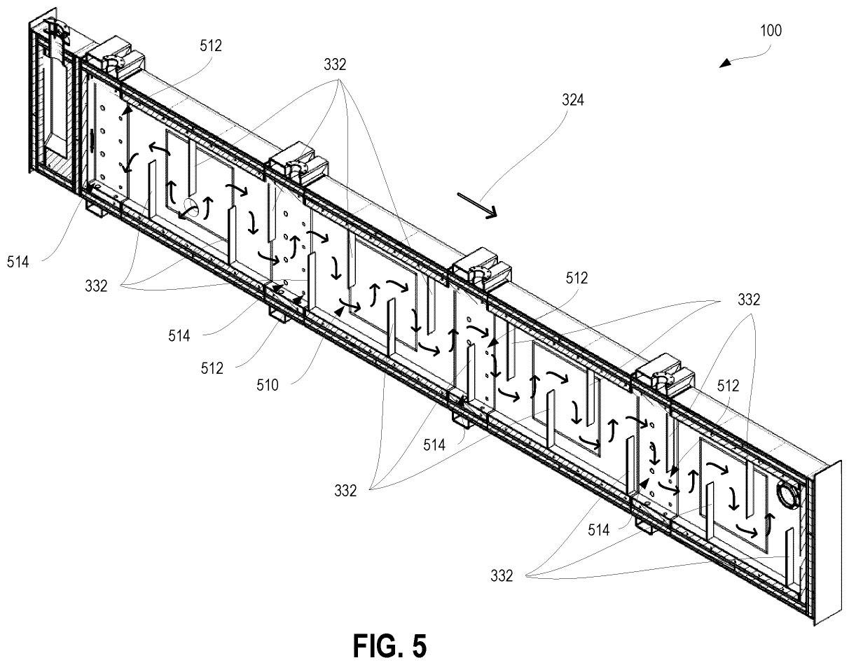

FIG. 5 is a cross-sectional view of the pyrolysis system 100 along 5-5 in FIG. 2A.

Exemplary flow paths 510 formed by the baffles 332 are shown with thick arrows in FIG. 5. Flow in the heating chamber 108 may be oriented from the outlet end 418 of the pyrolysis chamber 300 to the inlet end 416 of the pyrolysis chamber 300. A counterflow configuration may enhance heat transfer from the heating chamber 108 to the pyrolysis chamber 300. For example, hot gas may enter the heating chamber 108 adjacent to the outlet end 418.

A plurality of fuel nozzles 512 and a plurality of oxidizer nozzles 514 may be formed in the walls of the heating chamber 108 for injecting fuel and oxidizer to promote efficient mixing, e.g. via generation of turbulence. The plurality of fuel nozzles 512 and the plurality of oxidizer nozzles 514 may be configured to generate fuel and oxidizer jets, respectively, ejecting into the heating chamber 108.

The plurality of fuel ports 114 may be fluidly connected to the plurality of fuel nozzles 512 and the plurality of oxidizer ports 116 may be fluidly connected to the plurality of oxidizer nozzles 514.

In various embodiments, the plurality of fuel nozzles 512 and the plurality of oxidizer nozzles 514 may be nozzles or apertures in fluid communication with channels inside the heating chamber 108 walls that are fluidly connected to the one or more ports 114,116.

In some embodiments, each or one of the oxidizer nozzles 514 may have a larger cross-sectional area than each or one of the fuel nozzles 512.

The plurality of fuel nozzles 512 and the plurality of oxidizer nozzles 514 may be circumferentially distributed around the pyrolysis chamber 300 to encourage fuel and air mixing and distribution of fuel and oxidizer inside the pyrolysis chamber 300. The circumferential distribution may be along a continuous, closed surface normal to the longitudinal axis 410. For example, the surface may comprise four internal sides of the heating chamber 108 in a portion thereof proximal to a fuel port and oxidizer port pair. One of the four sides is shown in FIG. 5.

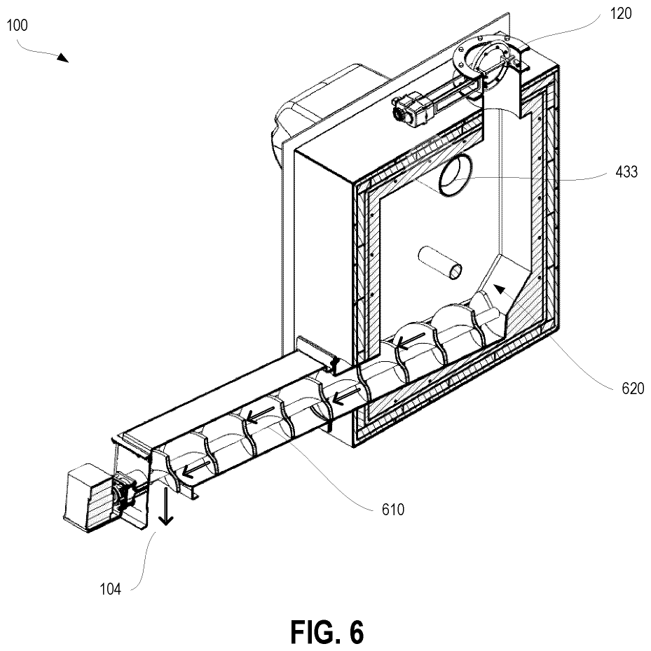

FIG. 6 is a cross-sectional view of the pyrolysis system 100 along 6-6 in FIG. 2B.

Exemplary material paths 620 are indicated by hollow-bodied arrows.

A lateral screw conveyer 610, driven by the electric motor 132, may convey products from the outlet end 418 of the pyrolysis chamber 300 to the first material outlet 104. As described previously, during shut-down of the pyrolysis system 100, gases may be controllably vented via the venting port 120.

The outlet duct 433 of the burner 432 may be heated by gases at the outlet end 418 of the pyrolysis chamber 300. For example, an outer surface of the outlet duct 433 may exposed to the gases, but flow inside the outlet duct 433 may be isolated from the gases. In some embodiments, heating the outlet duct 433 of the burner 432 may improve combustion and burning efficiencies.

As mentioned previously, the venting port 120 may remain closed during operation of the pyrolysis system 100.

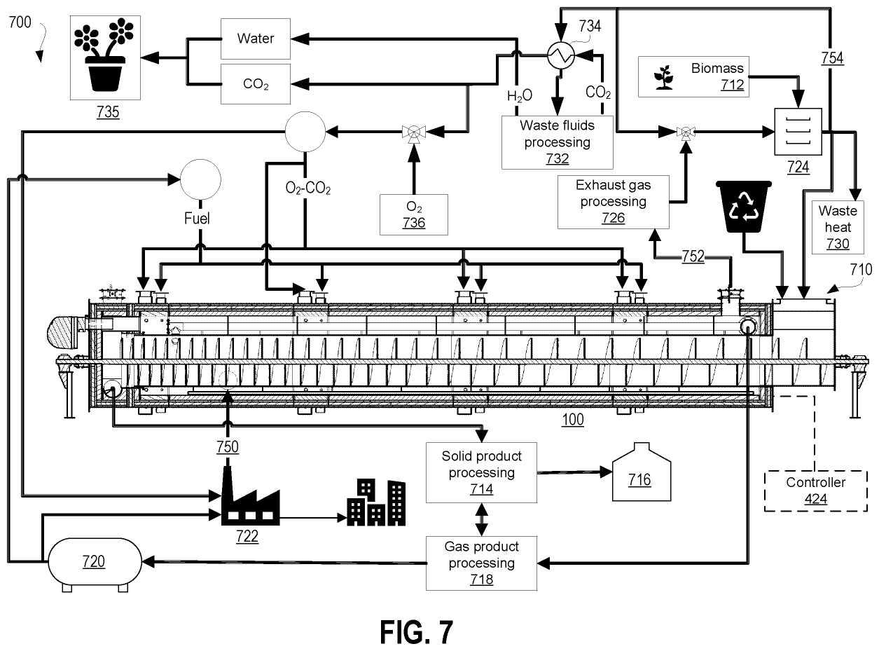

FIG. 7 is a schematic flow diagram of a process 700, in accordance with an embodiment.

Material received in the pyrolysis system 100 via the material inlet 102 may be a mixed waste stream 710. The mixed waste stream 710 may include organic material, such as wet biomass, and waste plastics. In some embodiments, the mixed waste stream 710 may include additional materials such as metals.

Biosolids may be obtained by processing biomass 712, e.g. wet biomass 712. The wet biomass 712 may be dried in a dryer 724.

Pyrolysis products from the first material outlet 104 may include residual organic materials, plastics, and metals. These products may be processed (see solid product processing 714) and then stored (see storage 716). In some embodiments, solid products released from the first material outlet 104 may have a mass of 20% or less of the mass of the solids supplied to the pyrolysis via the material inlet 102.

Gases vented from the venting port 120 may be gases from the pyrolysis chamber 300, e.g. when the pyrolysis system 100 is being shut-down.

Pyrolysis products from the second material outlet 106 may include fuels such as methane (renewable natural gas or RNG). In some embodiments, ethane, propane and/or other combustible hydrocarbon fuels may also be released from the second material outlet 106.

Fuel, such as RNG and other hydrocarbon fuels, generated by pyrolysis products may be processed (see gas product processing 718) and stored (see tank 720). In some embodiments, fuels may be stored as purified and liquified hydrocarbons. In some embodiments, RNG may be stored at ambient pressures and cryogenic temperatures.

Processing of fuel generated by pyrolysis products may include purifying by removing solid particles therefrom, e.g. by using cyclonic separators, cooling, compressing, and/or liquifying. In some embodiments, fuels may be separated and may be stored separately.

The fuel may then be used in a power generator 722 to generate power, e.g. via combustion of fuel with an oxidizer. For example, the power generator 722 may produce shaft power and/or electricity for power industrial or residential facilities. The shaft power may be used for generating electrical power and/or for power other parts of the process. In some embodiments, 7-8 times more fuel (by mass) may be supplied to the power generator 722 than fuel supplied to the pyrolysis system 100.

Oxidizer used in the power generator 722 may be controlled and combustion of fuels therein may not occur under open air. In some embodiments, the oxidizer used in the pyrolysis system 100 may be the same as the oxidizer used in the power generator 722.

Waste heat stored in hot gas from the power generator 722, e.g. hot combustion gases forming a (first) waste gas stream 750, may be fed into the pyrolysis system 100 to increase the temperature in the heating chamber 108 to increase efficiency, reduce waste heat, and facilitate autoignition.

In some embodiments, the pyrolysis system 100 may heat dried biomass using the waste gas stream 750 from the power generator 722 to generate another (or second or exhaust) waste gas stream 752.

This waste gas stream 752 may be used (in the pyrolysis system 100) to, at least in part, cause pyrolysis of the dried biomass to generate hydrocarbon fuels. In some embodiments, wet biomass 712 may be dried using exhaust gas from the pyrolysis system 100 to generate the dried biomass.

In some embodiments, hot gas may be received into the pyrolysis system 100 from another upstream industrial process. In some embodiments, the temperature of the hot gas entering the pyrolysis system 100 may be 650° C. or greater. For example, the upstream industrial process may include a heat source, such as a heat source generated by combustion.

The composition of hot (combustion) gases may be adapted to fluids and combustion in the heating chamber 108. The composition of combustion gases may be controlled via fuel and oxidizer feed to the power generator 722. By controlling composition, cost effective and environmentally beneficial operation of the entire process may be achieved. In some embodiments, combustion in the power generator 722 and the pyrolysis system 100 may involve the same reactions. In some embodiments, combustion in the power generator 722 and the pyrolysis system 100 may include reacting a partially recycled O₂—CO₂ oxidizer stream and fuel (such as RNG) generated by the pyrolysis system 100.

In some embodiments, the ratios of combustion reactants in the power generator 722 and pyrolysis system 100 may be substantially similar and/or configured to achieve complete combustion. In some embodiments, this ratio may be based on a stoichiometric ratio.

In some embodiments, exhaust gas released from the exhaust port 122 of the pyrolysis system 100 may have a temperature between 900-1000° C. In some embodiments, the exhaust gas stream 752 may have heat content (e.g. measured in units of power) substantially similar to or greater than heat content of hot gases entering the pyrolysis system 100 via the hot gas inlet 112. For example, in some embodiments, the heat content of the exhaust gas stream 752 may be 10-15% greater. By generating additional heat in the heating chamber 108, reliable pyrolysis and control pyrolysis processes may be ensured. For example, varying flow rate through the heating chamber 108 may be easier and faster to achieve than varying temperature.

In various embodiments, waste heat released from the exhaust port 122 may be used in the dryer 724 for a downstream drying process. Efficiency gains via usage of waste heat may partially or fully compensate for efficiency losses arising from heat losses sustained for achieving greater reliability and control over pyrolysis.

The exhaust gas may be fed as hot drying gas to a downstream dryer 724 after being processed (see exhaust gas processing 726) and mixed with a dryer exhaust stream 754. Processing of the exhaust gas may include removing particulate material, e.g. by use of a cyclonic separator. In some embodiments, mixing with the dryer exhaust stream 754 may be used to ensure the temperature of the hot drying gas entering the dryer 724 is reduced. For example, in some embodiments, the temperature of the hot drying gas may be 550° C.

Residual heat in the hot drying gas after passing through the dryer 724 may be sent to another industrial process or exhausted as waste heat 730.

Drying of wet biomass 712 received by the dryer 724 may generate dryer exhaust gas stream 754, and substantially dry or solid biomass. In various embodiments, the wet biomass 712 may include sewage and/or plant material suspended in liquids including water. The solid biomass may be fed to the pyrolysis system 100.

The dryer exhaust stream 754 may be yet another waste gas stream and may include CO₂, water vapour (e.g. in steam form), VOCs, and other gaseous substances released from the biomass during drying. In various embodiments, the dryer exhaust stream 754 may have a temperature of substantially 125° C. or greater.

In various embodiments, less than 60% or between 40-50% of the dryer exhaust stream 754 mass may be recycled back into the dryer 724, e.g. to ensure the temperature of the hot drying gas is in an appropriate range.

In various embodiments, greater than 40% or between 40-50% of the dryer exhaust stream 754 mass may be processed (see waste fluids processing 732) to generate a purified CO₂ stream, and a water stream. In some embodiments, additional output streams may be generated using the dryer exhaust stream 754. Processing of the dryer exhaust stream 754 may include separation of CO₂ and water vapour, condensation to form water, and scrubbing to remove contaminants and toxic substances.

In some embodiments, a heat exchanger 734 may be employed to utilize waste heat from the dryer exhaust stream 754 to heat the CO₂ stream.

In various embodiments, the CO₂ stream and/or the water stream may be used to grow plants (see block 735), e.g. for controlled environment agriculture and in greenhouses.

An oxygen generator 736 may generate oxygen (O₂). The CO₂ stream may be mixed with an O₂ stream from the oxygen generator 736 to generate the O₂—CO₂ oxidizer stream, which may then be fed to the pyrolysis system 100 and to the power generator 722. The O₂—CO₂ oxidizer stream may comprise substantially 25% or 20% O₂ by mass.

In some embodiments, the ratio of the O₂—CO₂ oxidizer stream to fuel in the heating chamber 108 and the power generator 722 may be stoichiometric ratios to facilitate clean and complete oxidation of the fuel.

The controller 434 may be connected to the pyrolysis system 100. The controller 434 may be connected to sensors and actuators to receive and transmit data. In various embodiments, the controller 434 may be configured to control oxidizer flows, fuel flows, rotation rate of the central shaft 424, inertia of the power generator, various valves, dryer speed (residence time of material to be dried within the dryer 724), CO₂ flows, O₂ flow, and water flow.

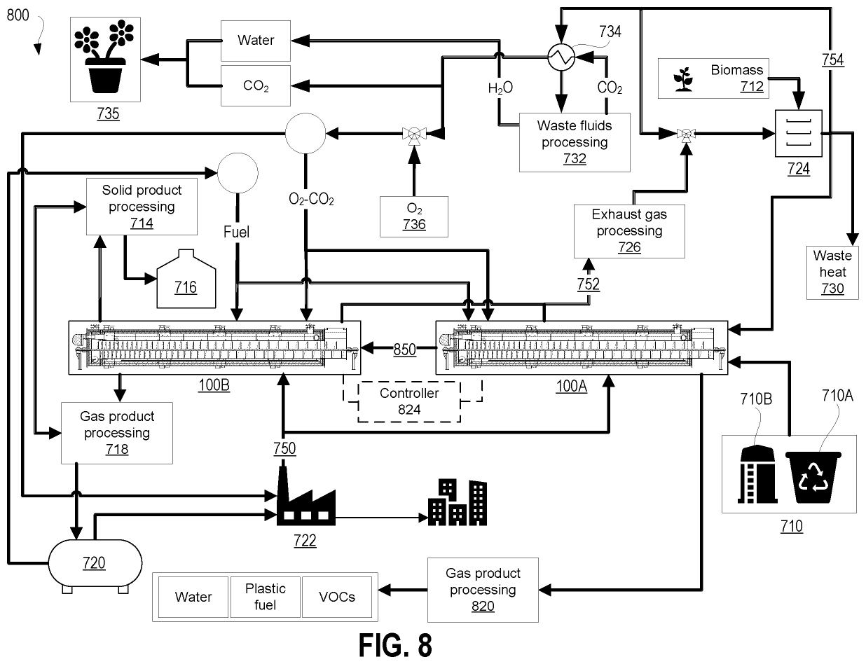

FIG. 8 is a schematic flow diagram of a process 800 for processing a mixed waste stream 710, in accordance with a further embodiment.

The mixed waste stream 710 may include a plurality of materials. For example, in some embodiments, a first material 710A of the mixed waste stream 710 may include plastics and a second material 710B of the mixed waste stream 710 may include organic materials.

The process may be used to thermally sort the materials in the mixed waste stream 710. For example, in some embodiments, using a mixed waste stream 710 directly may reduce costs of mechanical and/or manual sorting of waste.

A plurality of pyrolysis systems may be arranged in sequence. A first pyrolysis system 100A may process the mixed waste stream 710 and provide feed for a second pyrolysis system 100B.

The first pyrolysis system 100A may be configured to generate a first group of pyrolysis products. The first pyrolysis system 100A may pyrolyze the mixed waste stream 710 under conditions configured to cause pyrolysis of the first material 710A and hinder pyrolysis of the second material 710B.

The first group of pyrolysis products may be separated to generate a residual waste stream 850. The residual waste stream 850 may include the second material 710B. In some embodiments, the residual waste stream 850 may be substantially free of the first material 710A.

The second pyrolysis system 100B may be configured to generate a second group of pyrolysis products. The second pyrolysis system 100B may pyrolyze the residual waste stream 850 under conditions configured to cause pyrolysis of the second material 710B.

The selective pyrolysis of the first system may be achieved by controlling temperature, pressure, presence of catalyst, and/or residence time of the material in the first pyrolysis system 100A. The factors governing selective pyrolysis may be predetermined. For example, in some embodiments, the first material 710A may undergo pyrolysis at a lower temperature than the second material 710B.

For example, in some embodiments, the first pyrolysis system 100A may be configured to flash plastics only. Pyrolysis of plastics may partially or fully liberate the mixed waste stream 710 of solid plastics to generate organic and inert products as the first group of pyrolysis products. The organic and inert products may then be used as feed for the second pyrolysis system 100B. In various embodiments, controlling temperature and residence may prevent simultaneous pyrolysis of plastics, organics, and inert materials.

In some embodiments, separation of the first group of pyrolysis products may be combined with pyrolysis in the first pyrolysis system 100A. For example, pyrolysis may generate gases, which may be drawn off from the pyrolysis system. The remaining solid materials may form the residual waste stream 850.

For example, waste plastics may be fully or partially composed of polyethylene (PE) waste. PE is the most widely used consumer plastic in the world and is used to make food wrap, shopping bags, car parts, and other common articles. Table 3 details the pyrolysis of 1 kg of PE (chemical formula (C₂H₄)ₙ). Example pyrolysis products are listed, including molar enthalpy change associated with the reaction (ΔH_{R}), molar enthalpy change in the products (ΔH), and molar enthalpy change of vaporization (ΔH_{V}) if involved, and the total energy needed for pyrolysis. Increasing heating, e.g. by increasing temperature or passing products through additional pyrolysis systems, may facilitate breakdown of longer-chain hydrocarbons.

TABLE 3

| | C₃H₆ | 1-C₈H₁₆ | 1-C₁₆H₃₂ | 1-C₂₈H₅₆ | Total |
|---|---|---|---|---|---|
| Weight ratio | 0.10 | 0.30 | 0.40 | 0.20 | 1.00 |
| Mol | 2.38 | 2.68 | 1.79 | 0.51 | 7.36 |
| ΔH_{R} (kJ mol⁻¹) | 23.00 | 23.00 | 23.00 | 23.00 | 169.18 |
| ΔH (kJ mol⁻¹) | 24.12 | 72.32 | 163.34 | 304.12 | 697.98 |
| ΔH_{V} (kJ mol⁻¹) | — | 33.76 | 50.42 | — | 180.46 |
| Total Energy (kJ) | 112.19 | 345.75 | 422.79 | 166.90 | 1047.62 |

The hydrocarbons generated from pyrolysis of plastic may be used as fuel for making power and generating heat, among other uses. For example, such hydrocarbons may be referred to as “plastic fuel” or “plastic crude” (liquids or gases) that may be used to make new virgin plastics.

In some embodiments, some part of the first group of pyrolysis products may be processed to obtain water, plastic fuels, and/or VOCs (see gas product processing 820).

For example, in some embodiments, the second pyrolysis system 100B may be configured to pyrolyze organic matter to generate fuel for powering the power generator. Such pyrolysis may occur at higher temperatures than may be needed for pyrolysis of plastics and may also require longer residence times. In some embodiments, organics may be dry. In some embodiments, organics may produce water when pyrolyzed. This water may be recycled, e.g. for use in a greenhouse. The second pyrolysis system 100B may also flash VOCs out of the residual waste stream 850.

“Thermally staged” methods may allow for isolation, sorting, concentration of the plastic molecules to be separated from the rest of the organics and inert materials/metals.

Staged pyrolysis or multi-stage pyrolysis may be achieved by sequential arrangements of two or more pyrolysis systems. Such daisy-chained pyrolysis systems may together provide a molecular recycling capability via thermal sorting. As described previously, in some embodiments, multi-stage pyrolysis may be achieved with one pyrolysis system by staging pyrolysis in the pyrolysis chamber 300, and additionally in the tubular ducts 310.

In some embodiments, staged pyrolysis may be achieved using a single pyrolysis system 100, by bleeding gases from longitudinally-separated locations of pyrolysis chamber 300 of the pyrolysis system 100 and controlling pyrolysis conditions at respective longitudinally separated (or adjacent) portions of the pyrolysis chamber 300.

In some embodiments, the first pyrolysis system 100A may include a catalyst and/or a carrier. For example, the first pyrolysis system 100A may include char, or ash. The carrier may allow plastics to be transported via a liquid phase or relatively more fluid phase. For example, in some embodiments, plastics may adhere to char particles which may carry the plastics through the pyrolysis system until plastics are pyrolyzed and/or vaporized.

In some embodiments, the mixed waste stream 710 may include different types of plastics. For example, the mixed waste stream 710 may include chlorinated plastics such as polyvinyl chloride (PVC). In some cases, chlorine compounds may be undesirable molecules in waste plastic and in recycled plastic-oils to be used for making new plastic.

In some embodiments, the first pyrolysis system 100A may pyrolyze chlorinated plastics or remove chlorine from chlorinated plastics. For example, in some embodiments, the first pyrolysis system 100A may be a dechlorinating apparatus. Chlorine may disassociate at low temperatures from some plastics, e.g. PVC. For example, in some embodiments, chlorine removed from the mixed waste stream 710 may be exhausted or mixed with water and released, which may at least partially remove a need for an additional separation step to obtain the residual waste stream 850. In some embodiments, the residual waste stream 850 may then be substantially free of chlorine. In some embodiments, the residual waste stream 850 may comprise or consist of non-chlorinated plastics. The second pyrolysis system 100B may then pyrolyze the residual waste stream 850.

In various embodiments, a controller 834 (e.g. for controlling pyrolysis processes) may be connected to the first and/or second pyrolysis systems 100A, 100B.

In some embodiments, the first pyrolysis system 100A may operate under 400° C. to pyrolyze plastics without substantial biomass pyrolysis, and the second pyrolysis system 100B may operate above 600° C. to pyrolyze biomass. In some embodiments, the first group of products (and/or residual waste stream) may include products from (partial) pyrolysis of organic materials having a relatively lower pyrolysis temperature, e.g. cellulose. In some embodiments, the first group of products (and/or residual waste stream 850) may include products from (partial) pyrolysis of plastic products having a relatively higher pyrolysis temperature. In some embodiments, operational temperatures of the first pyrolysis system 100A may be decreased below 400° C. to obtain greater yields of plastics in the first group of pyrolysis products and/or the residual waste stream 850. In some embodiments, pyrolysis of plastics may occur in stages to separate various types of plastics. As mentioned previously, products may be recycled back into pyrolysis systems for additional pyrolysis, and/or additional pyrolysis steps may involve de-watering, de-chlorination, and/or other steps.

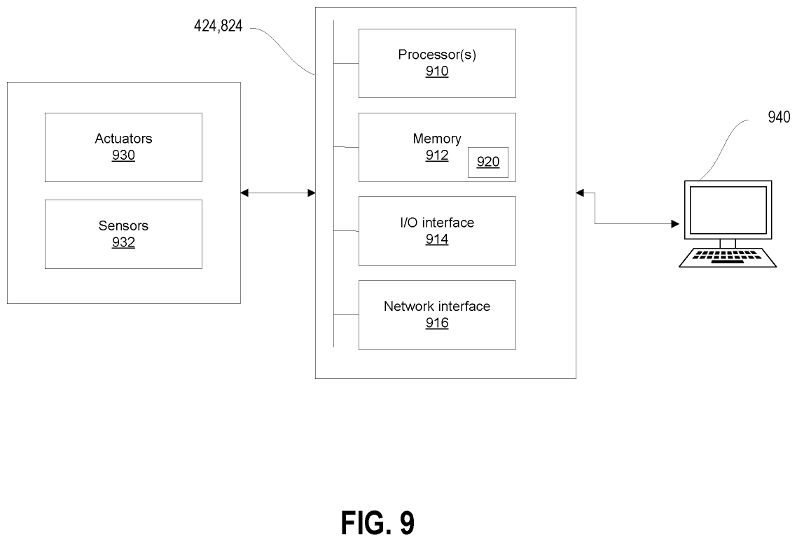

FIG. 9 is a schematic diagram of the controller 434, 834 for a pyrolysis system 100, in accordance with an embodiment.

The controller 434, 834 may comprise computer-readable memory 912 having instructions 920 stored thereon. The instructions 920 may be configured to cause one or more processors 910 to execute one or more methods. For example, the instructions 920 may be configured to control the pyrolysis processes based on inputs from sensors 932, e.g. temperature and pressure gauges in the heating chamber 108, pyrolysis chamber 300, and/or tubular ducts 310. In multi-stage pyrolysis, the controller 434, 834 may be configured to control more than one pyrolysis system based on input from one or more pyrolysis systems 100.

In some embodiments, the controller 434, 834 may be configured to run the pyrolysis at various temperature profiles. For example, each temperature profile may correspond to a group of one or more to achieve thermal sorting of a mixed waste stream.

In various embodiments, the controller 434, 834 may be configured to command actuators 930 for controlling pyrolysis processes and/or achieving target objectives. For example, the controller 434, 834 may command valves (for fuel, oxidizer, and hot gas), power provided to electric motors, and other actuatable components.

In some embodiments, the controller 434, 834 may comprise an I/O interface 914 or an interface adapter for one or two-way communication of the controller 434, 834 with one or more other (external) components. In some embodiments, a terminal and/or graphical user interface (GUI) 940 may be connected to the controller 434, 834. The controller 434, 834 may be controlled and/or adapted by an operator via the terminal or the GUI 940. In some embodiments, the controller 434, 834 may comprise a network interface 916, e.g. to communicate with the terminal, the sensors 932 and/or the actuators 930, or connect to local area network, wide area network, and/or the internet.

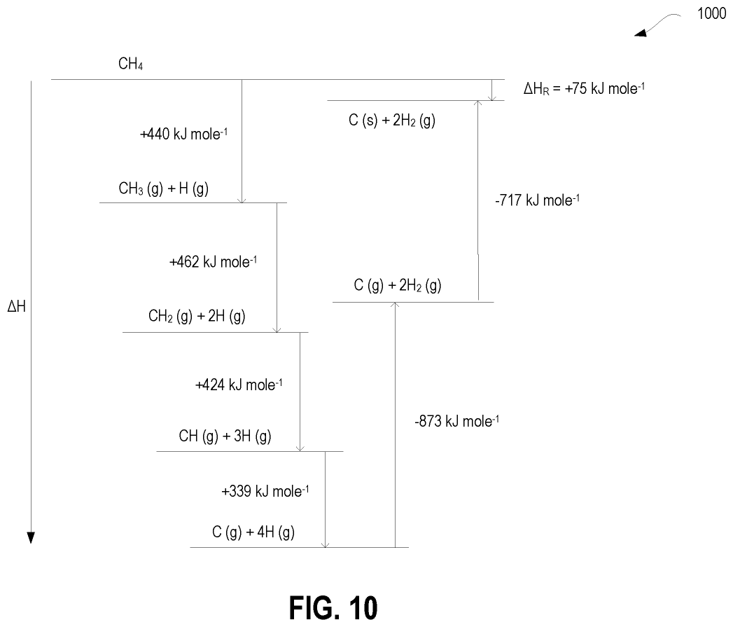

FIG. 10 is an exemplary enthalpy diagram 1000 for methane pyrolysis to generate hydrogen.

Pyrolysis of methane may involve an enthalpy of reaction of +75 kJ mol⁻¹.

To generate hydrogen, hydrogen atoms may be sequentially removed from carbon, to form solid carbon and gaseous hydrogen. In some embodiments, efficient capturing latent heat of vaporization may be necessary to achieve the enthalpy of reaction of 75 kJ mol⁻¹.

In some embodiments, catalysts may be used for methane pyrolysis. Catalysts may enable alternative reaction pathways.

In various embodiments, the pyrolysis system 100 may be a multi-pass pyrolysis system 100, wherein products of the pyrolysis system 100 may be recycled therethrough for achieving higher purity or alternative products. For example, for methane pyrolysis, products may be a mixture of hydrogen and methane. In some cases, products may be processed prior to recycling through the pyrolysis system 100.

In some embodiments, by-product carbon may be transported through the pyrolysis system 100 using the screw conveyer 420 while methane is injected into the pyrolysis system 100, particularly in the material in the screw conveyer 420. In some embodiments, hydrogen production may be enhanced, particularly first-pass production. Enhanced production may occur via catalytic effect of carbon.

In various embodiments, gases released by the pyrolysis system 100 may be a mixture of hydrogen and methane. In some embodiments, a molecular sieve may be used to separate hydrogen and unreacted methane. Unreacted methane may then be recycled into the pyrolysis system 100 in a second-pass pyrolysis.

Table 4 shows a product distribution and energy balance of the various products produced from pyrolysis of low-density polyethylene (LDPE) at low reflux rates and high reflux rates.

Low reflux rate products may be first-pass products or those that may be easily pyrolyzed, while high reflux rate products may require multiple passes through the pyrolysis system 100.

TABLE 4

| 20 g LDPE | C₃H₆ | 1-C₈H₁₆ | 1-C₁₆H₃₂ | 1-C₂₈H₅₆ | Total |
|---|---|---|---|---|---|
| ΔH_{R} (kJ mol⁻¹) | 23.00 | 23.00 | 23.00 | 23.00 | |
| ΔH (kJ mol⁻¹) | 24.12 | 72.32 | 163.34 | 304.12 | |
| ΔH_{V} (kJ mol⁻¹) | — | 33.76 | 50.42 | — | 181 |
| Low reflux products | 7% | 22% | 50% | 21% | 100% |
| mol of component | 0.33 | 0.39 | 0.44 | 0.11 | 0.128 |
| Energy required (kJ) | 1.57 | 5.9 | 10.51 | 3.54 | 20.71 |
| High reflux products | 15% | 31% | 44% | 11% | 100% |
| mol of component | 0.72 | 0.55 | 0.39 | 0.005 | 0.171 |
| Energy required (kJ) | 3.39 | 7.8 | 9.22 | 1.77 | 21.45 |

Table 5 shows gas, solid, and oil yields obtained from pyrolysis of various types of biomass. Increasing temperature may increase gas yields. In various embodiments, oil yield may include turpentine and/or may be recycled back into a pyrolysis system for additional pyrolysis.

In Table 5, mass balance in terms of weight percent ratio (wt %) may exceed 100% due to experimental anomalies, measurement artifacts, and/or other sources of error.

In various embodiments, the second pyrolysis system 100B may operate above 750° C., 850° C., 950° C., or 1050° C. For example, the first pyrolysis system 100A may be operated at lower temperatures, which may facilitate pyrolysis of non-biomass material and hinder pyrolysis of biomass material.

TABLE 5

| | Pyrolysis temperature (° C.) | | | |
|---|---|---|---|---|
| Feedstock/products | 750 | 850 | 950 | 1050 |
| Wood (wt %) | | | | |
| Gas | 75.81 | 78.63 | 81.87 | 87.61 |
| Gas (ash-free) | 79.36 | 82.31 | 85.70 | 91.71 |
| Solid | 10.39 | 9.63 | 6.26 | 4.32 |
| Oil | 16.41 | 12.31 | 10.00 | 8.40 |
| Mass balance (wt. %) | 102.61 | 100.57 | 98.13 | 100.33 |
| Rice Husks (wt %) | | | | |
| Gas | 60.43 | 66.61 | 74.55 | 77.43 |
| Gas yield (ash-free) | 76.77 | 84.62 | 94.70 | 98.36 |
| Solid | 20.60 | 16.21 | 15.86 | 13.21 |
| Oil | 12.01 | 10.22 | 8.13 | 6.19 |
| Mass balance (wt. %) | 93.4 | 93.4 | 98.54 | 96.83 |
| Forestry Residue (wt %) | | | | |
| Gas | 60.13 | 73.91 | 79.27 | 85.91 |
| Gas yield (ash-free) | 63.56 | 78.12 | 83.79 | 90.80 |
| Solid | 14.37 | 7.69 | 5.44 | 3.21 |
| Oil | 20.11 | 16.98 | 12.21 | 10.31 |
| Mass balance (wt. %) | 94.61 | 98.58 | 96.92 | 99.43 |

Table 6 shows the composition of gas yields tabulated in Table 5. Gas may be used as fuel for downstream processes (e.g. power generation). Increasing temperature of pyrolysis provides increased fuel, e.g. in the form of methane (CH₄).

TABLE 6

Pyrolysis temperature (° C.)

| Feedstock/products | 750 | 850 | 950 | 1050 |
|---|---|---|---|---|
| Wood (vol %) | | | | |
| CO | 45.12 | 47.10 | 45.94 | 48.74 |
| H₂ | 26.91 | 27.46 | 29.21 | 31.01 |
| CO₂ | 11.35 | 9.69 | 9.34 | 7.81 |
| CH₄ | 11.29 | 10.89 | 11.24 | 9.33 |
| C₂—C₄ | 5.33 | 4.86 | 4.28 | 3.11 |
| Rice Husk (vol %) | | | | |
| CO | 45.01 | 46.17 | 48.31 | 49.40 |
| H₂ | 21.84 | 25.32 | 27.83 | 30.30 |
| CO₂ | 15.6 | 12.98 | 11.33 | 8.65 |
| CH₄ | 11.92 | 10.65 | 8.94 | 8.67 |
| C₂—C₄ | 6.17 | 4.88 | 3.59 | 2.99 |
| Forestry residue (vol %) | | | | |
| CO | 43.8 | 46.6 | 48.7 | 46.61 |
| H₂ | 23.7 | 26.5 | 29.5 | 30.53 |
| CO₂ | 15.6 | 12.6 | 10.45 | 9.48 |
| CH₄ | 11.62 | 9.7 | 9.14 | 9.62 |
| C₂—C₄ | 6.1 | 4.5 | 3.29 | 3.76 |

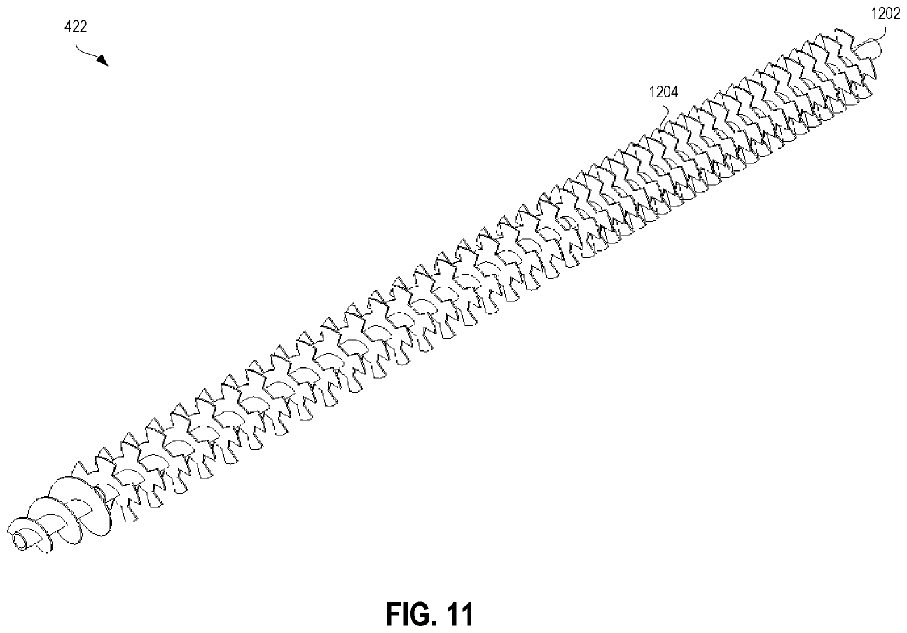

FIG. 11 is an isometric view of a screw 422 (or auger) of a screw conveyer 420, in accordance with an embodiment.

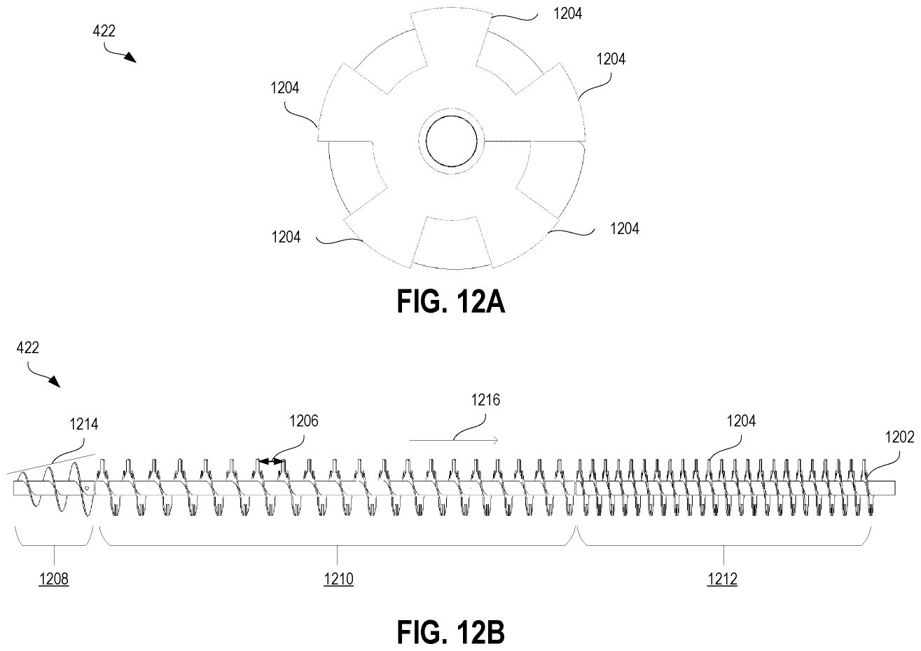

FIG. 12A is a front elevation view of the screw, in accordance with an embodiment.

FIG. 12B is a side elevation view of the screw, in accordance with an embodiment.

The screw 422 may be part of a screw conveyer 420 that is disposed inside the pyrolysis chamber 300 and is configured to receive the material to convey it along the pyrolysis chamber 300 as it is pyrolyzed therein.

The screw 422 has an inlet portion 1208 where it receives the material for pyrolysis and draws it in a longitudinal direction of the screw 422 (and the pyrolysis system 100). The casing of the screw 422 (not shown) may be generally cylindrical and/or tubular around the screw 422, e.g. areas of cross-sections of such a casing along the longitudinal direction may generally be equal to each other.

The screw conveyer 420 may be adapted for enhancing pyrolysis and reducing inefficiencies in pyrolysis. The solid mass of the material may generally vary in the pyrolysis chamber 300 due to pyrolysis. For example, the material may generate gases as it is pyrolyzed, which may in turn reduce solid mass of the material. Reducing solid mass may be associated with a reduction in solid volume. In some cases, e.g. pyrolysis of methane to generate hydrogen and solid carbon, solid mass may be generated due to pyrolysis. In this case, at least some of the solid mass may be drawn out of the pyrolysis chamber 300 to maintain a target amount of solid mass within the pyrolysis chamber 300, e.g. a target amount based on catalysis reactions caused or facilitated by the solid mass.

In some embodiments, the texture and porosity of the material may change as pyrolysis progresses. The solid mass or volume of the material may generally refer to mass or volume, respectively, of solid, semi-solid, and/or non-gaseous portion of the material, and may change as pyrolysis converts portions of the solid mass to gaseous products. The screw conveyer 420 may be configured such that efficiency losses due to reduction in solid mass of the material are reduced, e.g. by a geometry and/or dimensions of the screw conveyer 420.

As the material is conveyed in the longitudinal direction, it may undergo pyrolysis in sequence or stages. In some embodiments, pyrolysis products generated in the pyrolysis chamber 300 may be pyrolyzed further.

It is found that not only does the screw 422 provide a conveyance mechanism but it also improves heating and/or heat distribution in the pyrolysis chamber 300, including by absorbing and retaining heat in the pyrolysis chamber 300 using the screw 422. In particular, the screw 422 may facilitate pyrolysis by allowing greater conductive heat transfer to the material. In various embodiments, greater conductive heat transfer may be achieved by a flight 1202 of the screw 422 that is configured compact the material as the solid mass of the material is varied or reduced in the pyrolysis chamber 300. Compaction may reduce empty spaces (“dead spaces”) in the material and between the screw 422 and the material. This may improve efficiency and quality of pyrolysis. For example, the quality of pyrolysis may relate to an extent of pyrolysis, the fraction of the material undergoing complete pyrolysis, and/or homogeneity of the material after expulsion thereof from the pyrolysis chamber 300.

In various embodiments, the flight 1202 (e.g. geometry and/or dimensions thereof) may be configured based on at least one of the solid mass of the material, the solid volume of the material, a texture of the material, or a porosity of the material, to facilitate pyrolysis. For example, a lower solid mass, a texture that is looser or less dense, and higher porosity may each be associated with a greater need for compaction. In some cases, the material may be fluffy and sticky when pyrolysis is initiation and may become abrasive and sand-like when pyrolysis is complete.

In various embodiments, compaction may be achieved by varying a geometry of the screw 422 with length along the longitudinal direction or a direction in which there is increasing production of gaseous pyrolysis products and reduction in the solid mass of the material.

In some embodiments, the pitch of a flight 1202 of the screw 422 may be varied (an example pitch is labelled with a double-headed arrow 1206) so that the pitch is smaller when greater compaction is needed. In some embodiments, as a reduced pitch will reduce speed of conveyance, such a configuration is particularly advantageous as it may allow a more even flow of material through the pyrolysis chamber and greater retention time. This may improve quality of pyrolysis.

In some cases, a reduced pitch may be provided to increase retention time in a particular portion of the pyrolysis chamber 300. It is understood that portions of the pyrolysis chamber 300 may be associated with time and/or stages of pyrolysis since a speed profile (speed vs. location in the pyrolysis chamber) of the material in the pyrolysis chamber may be substantially predetermined. As such, changing the geometry of the screw 422 at a particular location in the pyrolysis chamber 300 may allow control of particular stages of the pyrolysis processes.

In some embodiments, the screw conveyer 420 may be configured to draw the material from a first portion 1210 to a second portion 1212, where the pitch of the flight 1202 is different or smaller in the second portion 1212 relative to the first portion 1210. In some embodiments, the pitch of the flight 1202 may be constant (i.e. does not very in the longitudinal direction) in each of the first portion 1210 and/or the second portion 1212 of the screw conveyer 420. For example, in some embodiments, the pitch of the flight 1202 in the second portion 1212 may be less than or about half of the pitch of the flight 1202 in the first portion 1210.

In some embodiments, the second portion 1212 of the screw conveyer 420 may be integrally formed with the first portion 1210 such that a relatively abrupt compaction force (related to change in pitch) is experienced by the material, which may be advantageous, e.g. for improved mixing.

In some embodiments, a third portion may be provided such that the screw conveyer 420 may be configured to draw the material from the second portion 1212 to the third portion of the screw conveyer 420. The pitch of the flight 1202 may be different or smaller in the third portion relative to the second portion 1212. This pitch in the third portion may be constant, in some embodiments. For example, in some embodiments, the pitch of the flight 1202 in the third portion may be less than or about half of the pitch of the flight 1202 in the second portion 1212. In some embodiments, advantageously, the second portion 1212 and third portion may be integrally formed.

In some embodiments, the pitch of the flight 1202 in the first portion 1210, second portion 1212, and third portion may be 24″, 12″, and 6″, respectively.

In some embodiments, the pitch of the flight 1202 may not only decrease, e.g. it may increase depending on predetermined characteristics of the material during pyrolysis.

In some embodiments, the inlet portion 1208 may be configured to draw the material from the inlet portion 1208 to the first portion 1210 of the screw conveyer 420. In various embodiments, the inlet portion 1208 may be integrally formed with the first portion 1210.

In various embodiments, the flight 1202 in the inlet portion 1208 may be tapered such that the material is drawn substantially evenly from an inlet end of the inlet portion 1208 to the first portion 1210. For example, intermittent flow of material may be reduced, or the amplitude of such intermittency may be reduced.

In various embodiments, tapering of the flight 1202 in the inlet portion 1208 may be a reverse tapering, i.e. opposite to the direction of flow of material. The tapering is generally indicated by a line 1214 bounding an upper edge of the flight 1202 and the direction of material flow is indicated by an arrow 1216.

In various embodiments, the inlet portion 1208, first portion 1210, second portion 1212, and/or third portion may be advantageously removably coupled to each other, e.g. by means of threaded fasteners. In some embodiments, they may be formed in unitary construction (at least two or more), e.g. by solid state diffusion, and/or additive manufacturing.

In some embodiments, as shown in FIGS. 11 and FIGS. 12A-12B, the screw 422 may comprise a plurality of paddles 1204 for encouraging mixing of the material as it is conveyed. Such mixing may ensure uniform and homogenous (or more uniform and more homogenous) temperature and/or heat distribution in the material to improve pyrolysis. Additionally, it is found that the mixing may improve conductive heat transfer from the screw 422 by allowing a greater amount of material to contact the screw surface.

In various embodiments, the plurality of paddles may extend radially outwardly from the flight 1202 (or a central shaft 424 of the screw 422 or flight 1202) to cause mixing of the material while it is conveyed through the pyrolysis chamber. In some embodiments, the paddles may be varied to achieve mixing based on compaction.

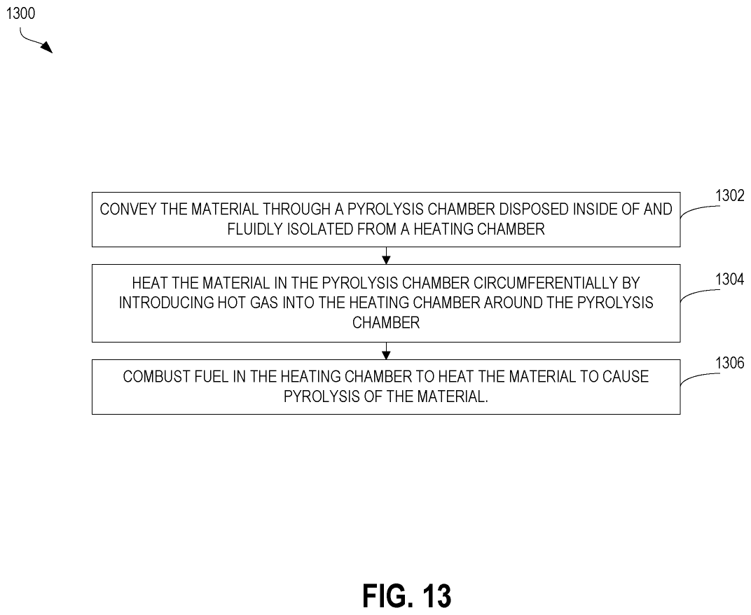

FIG. 13 is a flow chart of a method 1300 of pyrolyzing material, in accordance with an embodiment.

At step 1302, the method 1300 includes conveying the material through a pyrolysis chamber disposed inside of and fluidly isolated from a heating chamber.

At step 1304, the method 1300 includes heating the material in the pyrolysis chamber circumferentially by introducing hot gas into the heating chamber around the pyrolysis chamber.

At step 1306, the method 1300 includes combusting fuel in the heating chamber to heat the material to cause pyrolysis of the material.

Some embodiments of the method 1300 include receiving cooling fluid into the heating chamber to control a temperature in the heating chamber to control pyrolysis processes in the pyrolysis chamber.

Some embodiments of the method 1300 include metering fuel to the heating chamber to control the temperature in the heating chamber to control pyrolysis processes in the pyrolysis chamber.

Some embodiments of the method 1300 include metering oxidizer to the heating chamber to control the temperature in the heating chamber to control pyrolysis processes in the pyrolysis chamber.

In some embodiments, the temperature in the heating chamber is controlled based on a temperature sensed in the pyrolysis and/or heating chamber.

Some embodiments of the method 1300 include generating heat for use in an industrial process that is upstream of the heating chamber.

Some embodiments of the method 1300 include using the hot gas to carry a first portion of the heat to the heating chamber.

Some embodiments of the method 1300 include consuming a second portion of the heat in the industrial process.

In some embodiments, wherein generating the heat for use in the industrial process that is upstream of the heating chamber includes generating heat by combustion, the hot gas being a product of the combustion. In various embodiments, the industrial process may be an external heat source.

In some embodiments, wherein the industrial process is power generation.

In some embodiments, wherein pyrolysis of the material generates pyrolysis products.

Some embodiments of the method 1300 include drawing the pyrolysis products out of the pyrolysis chamber through the heating chamber while keeping the pyrolysis products fluidly isolated from the heating chamber.

In some embodiments, pyrolysis of the material generates first pyrolysis products and second pyrolysis products, the first pyrolysis products being lighter than the second pyrolysis products

Some embodiments of the method 1300 include drawing the first pyrolysis products away from the pyrolysis chamber separately from the second pyrolysis products by allowing the first pyrolysis products to rise above the second pyrolysis products to separate from the second pyrolysis products.

In some embodiments, the pyrolysis of the material generates pyrolysis products

Some embodiments of the method 1300 include drawing gaseous pyrolysis products out of the pyrolysis chamber through the heating chamber while keeping the gaseous pyrolysis products fluidly isolated from the heating chamber

Some embodiments of the method 1300 include hindering solid pyrolysis products from leaving the pyrolysis chamber with the gaseous pyrolysis products.

Some embodiments of the method 1300 include heating catalysts using the heating chamber while keeping the catalysts fluidly isolated from the heating chamber.

Some embodiments of the method 1300 include using the catalysts to facilitate pyrolysis in the pyrolysis chamber.

Some embodiments of the method 1300 include ejecting a plurality of fuel jets into the heating chamber and circumferentially around the pyrolysis chamber for combustion around the pyrolysis chamber.

Some embodiments of the method 1300 include ejecting a plurality of oxidizer jets into the heating chamber and circumferentially around the pyrolysis chamber for reaction with fuel from the plurality of fuel jets.

In some embodiments, the material includes a hydrocarbon, and pyrolysis of the material is configured to generate hydrogen and solid carbon.

Some embodiments of the method 1300 include using the solid carbon in the pyrolysis chamber to enhance pyrolysis of the hydrocarbon to generate hydrogen.

Some embodiments of the method 1300 include supplying water and oxygen to the pyrolysis chamber to cause a water gas shift reaction.

In some embodiments, the hydrocarbon is methane.

In some embodiments, the material includes waste material.

In some embodiments, the pyrolysis of the material generates a fuel

Some embodiments of the method 1300 include combusting the fuel in the heating chamber to provide heat to the pyrolysis chamber.

In some embodiments, the pyrolysis of the material generates solid carbon that is granular

Some embodiments of the method 1300 include cyclonically separating the fuel from the solid carbon before combusting the fuel in the heating chamber.

In some embodiments, the material is a mixed waste stream including a first material and a second material

Some embodiments of the method 1300 include generating a first group of pyrolysis products by pyrolyzing, in the pyrolysis chamber, the mixed waste stream under conditions configured to cause pyrolysis of the first material and hinder pyrolysis of the second material.

Some embodiments of the method 1300 include drawing out the first group of pyrolysis products from the pyrolysis chamber to generate a residual waste stream, in the pyrolysis chamber, that includes the second material.

Some embodiments of the method 1300 include generating a second group of pyrolysis products by pyrolyzing, in the pyrolysis chamber, the residual waste stream under conditions configured to cause pyrolysis of the second material.

In some embodiments, generating the first group of pyrolysis products by pyrolyzing, in the pyrolysis chamber, the mixed waste stream under conditions configured to cause pyrolysis of the first material and hinder pyrolysis of the second material includes causing pyrolysis of the first material in a first portion of the pyrolysis chamber.

In some embodiments, generating the second group of pyrolysis products by pyrolyzing, in the pyrolysis chamber, the residual waste stream under conditions configured to cause pyrolysis of the second material includes causing pyrolysis of the second material in a second portion of the pyrolysis chamber.

In some embodiments, conveying the material through the pyrolysis chamber disposed inside of and fluidly isolated from the heating chamber includes conveying the mixed waste stream through the first portion of the pyrolysis chamber as the mixed waste stream is being pyrolyzed.

Some embodiments of the method 1300 include conveying the second material through the second portion of the pyrolysis chamber as the second material is being pyrolyzed.

In some embodiments, the material is a mixed waste stream including a first material and a second material, the pyrolysis chamber is a first pyrolysis chamber.

Some embodiments of the method 1300 include generating a first group of pyrolysis products by pyrolyzing, in the first pyrolysis chamber, the mixed waste stream under conditions configured to cause pyrolysis of the first material and hinder pyrolysis of the second material.

Some embodiments of the method 1300 include separating out the first group of pyrolysis products to generate a residual waste stream including the second material.

Some embodiments of the method 1300 include generating a second group of pyrolysis products by pyrolyzing the residual waste stream, in a second pyrolysis chamber separate from the first pyrolysis chamber, under conditions configured to cause pyrolysis of the second material.

In some embodiments, the heating chamber is a first heating chamber, the hot gas is a first hot gas, the fuel is a first fuel.

In some embodiments, the step of generating the second group of pyrolysis products by pyrolyzing the residual waste stream, in a second pyrolysis chamber separate from the first pyrolysis chamber, under conditions configured to cause pyrolysis of the second material includes conveying the residual waste stream through the second pyrolysis chamber, the second pyrolysis chamber disposed inside of and fluidly isolated from the second heating chamber; heating the residual waste stream in the second pyrolysis chamber circumferentially by introducing a second hot gas into a second heating chamber around the second pyrolysis chamber; and combusting a second fuel in the heating chamber to heat the residual waste stream to cause pyrolysis of the residual waste stream.

In some embodiments, the material is dried biomass, combusting fuel in the heating chamber to heat the material to cause pyrolysis of the material includes combusting a hydrocarbon fuel generated by pyrolysis of dried biomass to generate heat and first waste gas, the dried biomass and second waste gas being generated by drying of wet biomass, the first waste gas and second waste gas being used for drying of wet biomass.

In some embodiments, pyrolyzing the material reduces solid mass of the material

Some embodiments of the method 1300 include compacting the material in the pyrolysis chamber to facilitate pyrolysis as the solid mass (and/or solid volume) of the material is reduced due to pyrolysis.

In some embodiments, compacting the material in the pyrolysis chamber to facilitate pyrolysis as the solid mass of the material is reduced includes conveying the material through the pyrolysis chamber as the material is pyrolyzed to compact the material.

In some embodiments, conveying the material through the pyrolysis chamber as the material is pyrolyzed to compact the material includes using a screw conveyer defining a flight having variable pitch to convey the material.

Some embodiments of the method 1300 include mixing the material in the pyrolysis chamber as the solid mass of the material is reduced.

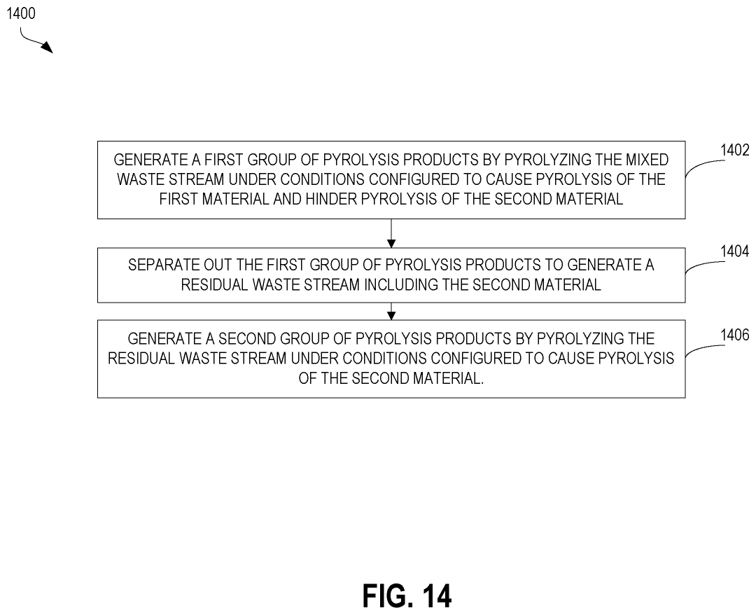

FIG. 14 is a flow chart of a method 1400 processing a mixed waste stream including a first material and a second material, in accordance with an embodiment.

At step 1402, the method 1400 includes generating a first group of pyrolysis products by pyrolyzing the mixed waste stream under conditions configured to cause pyrolysis of the first material and hinder pyrolysis of the second material.

At step 1404, the method 1400 includes separating out the first group of pyrolysis products to generate a residual waste stream including the second material.

At step 1406, the method 1400 includes generating a second group of pyrolysis products by pyrolyzing the residual waste stream under conditions configured to cause pyrolysis of the second material.

In some embodiments, wherein the mixed waste stream includes plastics and organic waste.

In some embodiments, the pyrolysis of the first material and the pyrolysis of the second material occur in separate pyrolysis chambers.

In some embodiments, the pyrolysis of the first material and the pyrolysis of the second material occur in separate portions of a pyrolysis chamber.

In some embodiments, the pyrolysis of the first material and the pyrolysis of the second material is achieved below atmospheric pressure.

In some embodiments, generating a first group of pyrolysis products by pyrolyzing the mixed waste stream under conditions configured to cause pyrolysis of the first material and hinder pyrolysis of the second material includes causing pyrolysis of the first material in a pyrolysis chamber heated by combustion in a heating chamber, and metering fuel to the heating chamber to control a temperature of the pyrolysis chamber.

In some embodiments, the conditions configured to cause pyrolysis of the first material and hinder pyrolysis of the second material include a first temperature and a first pressure, and the conditions configured to cause pyrolysis of the second material include a second temperature and a second pressure.

In some embodiments, the second group of pyrolysis products includes a fuel, the fuel being combusted for generating power.

In some embodiments, the hot gases generated by combusting the fuel are used for causing pyrolysis.

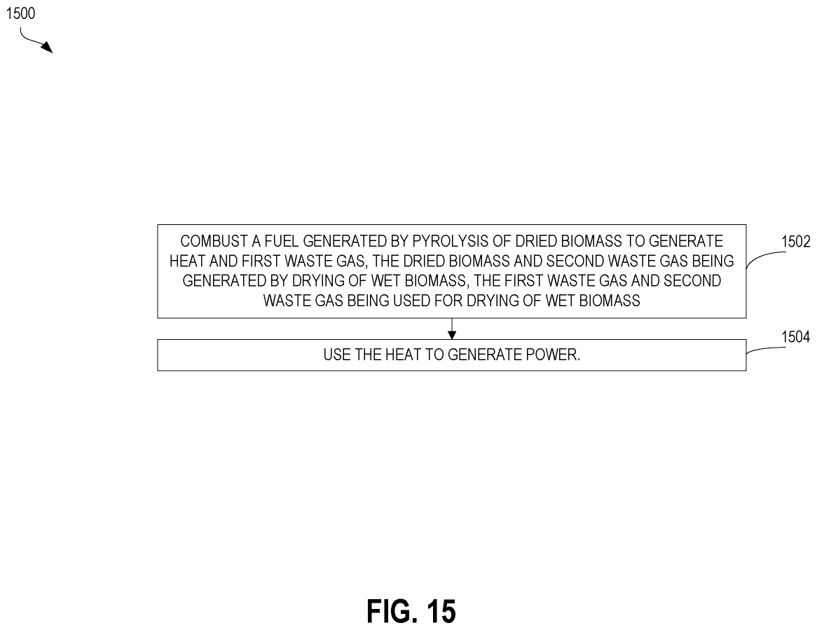

FIG. 15 is a flow chart of a method 1400 of generating power using wet biomass, in accordance with an embodiment.

At step 1502, the method 1500 includes combusting a fuel generated by pyrolysis of dried biomass to generate heat and first waste gas, the dried biomass and second waste gas being generated by drying of wet biomass, the first waste gas and second waste gas being used for drying of wet biomass.

At step 1504, the method 1500 includes using the heat to generate power.

In some embodiments, using the heat to generate power includes generating shaft power using the heat generated by combusting the fuel, and using the shaft power to generate electrical power.

In some embodiments, the pyrolysis of the dried biomass generates pyrolysis-generated fuel to be used for combustion to generate heat for pyrolysis.

In some embodiments, wherein combusting the fuel includes reacting the fuel with an oxidizer, the oxidizer including oxygen and carbon dioxide,

Some embodiments of the method 1500 include processing at least a portion of the second waste gas to generate the carbon dioxide in the oxidizer.

In some embodiments, the fuel is a hydrocarbon fuel.

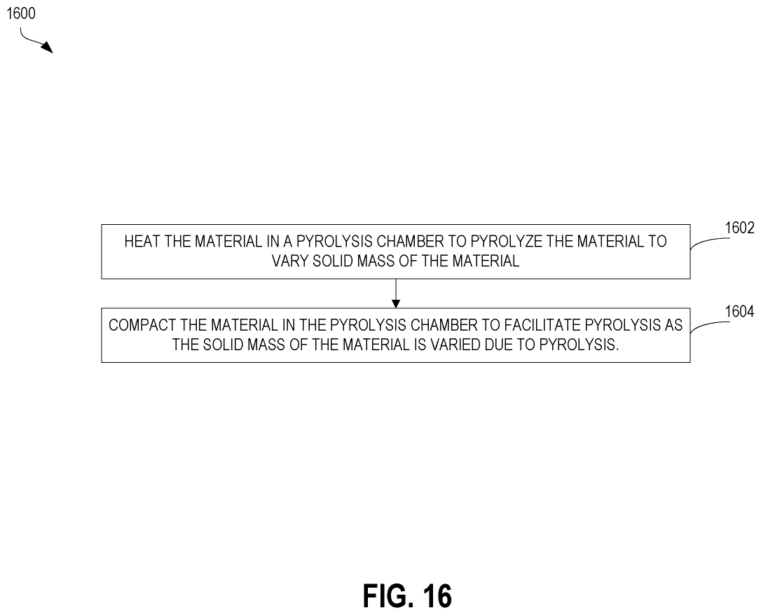

FIG. 16 is a flow chart of a method 1600 of pyrolyzing material, in accordance with an embodiment.

At step 1602, the method 1600 includes heating the material in a pyrolysis chamber to pyrolyze the material to vary or reduce the solid mass of the material.

At step 1604, the method 1600 includes compacting the material in the pyrolysis chamber to facilitate pyrolysis as the solid mass of the material is varied or reduced due to pyrolysis.

In some embodiments, compacting the material in the pyrolysis chamber to facilitate pyrolysis as the solid mass of the material is varied includes conveying the material through the pyrolysis chamber as the material is pyrolyzed to compact the material.

In some embodiments, conveying the material through the pyrolysis chamber as the material is pyrolyzed to compact the material includes using a screw conveyer defining a flight having variable pitch to convey the material.

Some embodiments of the method 1600 include mixing the material in the pyrolysis chamber as the solid mass of the material is reduced.

As can be understood, the examples described above and illustrated are intended to be exemplary only.

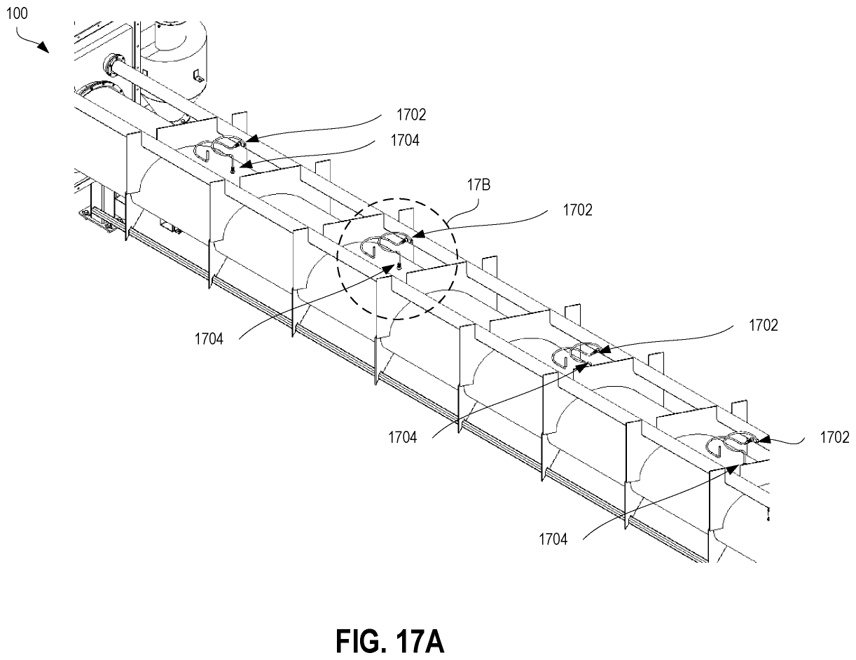

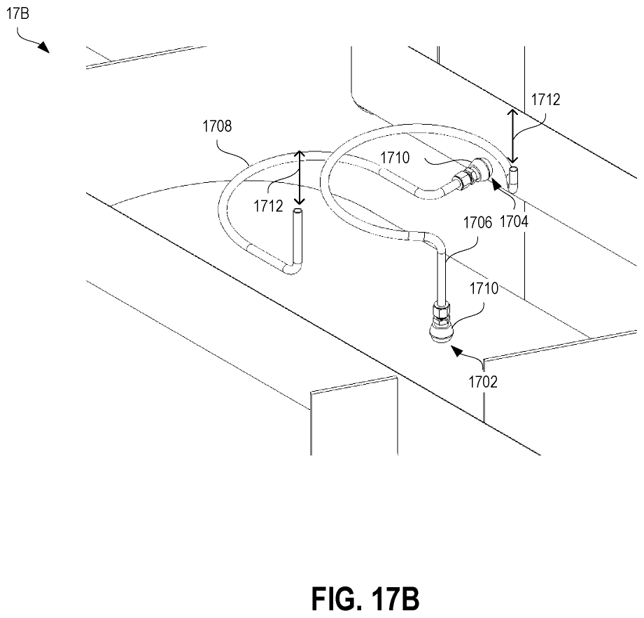

FIG. 17A is a partial isometric view of a pyrolysis chamber 300 of a pyrolysis system 100, as shown by removing an outer body at least partially defining a heating chamber 108 of the pyrolysis system, in accordance with an embodiment.

FIG. 17B is an enlarged isometric view of region 17B in FIG. 17A.

The pyrolysis system 100 shown in FIGS. 17A-17B may be particularly suitable for separation of molecular species generated during pyrolysis.

The pyrolysis chamber 300 may comprise a plurality of ports 1702 that are longitudinally separated and connected to respective conduits 1706. Similarly, the tubular ducts 310 may comprise a plurality of ports 1704 that are longitudinally separated and connected to respective conduits 1708. The ports 1702, 1704 may release or bleed gaseous pyrolysis products from the ports 1702, 1704 via the respective conduits 1706, 1708. This may allow selective bleeding or drawing out of pyrolysis products, thereby allowing selective production of chemical compounds, as described previously. In various embodiments, the ports 1702, 1704 may be configured to bleed evaporating materials that are not pyrolyzed, e.g. water vapour generated from moisture in input materials.

As shown in Tables 1-6 and FIG. 10, progressive addition of energy may cause progressive pyrolysis of materials and thus intermediate bleeding of gaseous products may allow extraction of intermediate products. Additionally, certain species may be generated at lower energy than other species and thus intermediate bleeding via the ports 1702, 1704 may obviate a need of processing of a final pyrolysis product stream, e.g. separation of species in separators.

In some embodiments, the ports 1702, 1704 may be used to inject substances into the pyrolysis chamber 300 and/or the tubular ducts 310, e.g. to achieve a water gas shift reaction as described previously.

The ports 1702, 1704 may comprise connectors 1710 configured to maintain intrusion of ambient air into the tubular ducts 310 and the pyrolysis chamber 300. The connectors 1710 may defined threaded connections that may be advantageous, e.g. including for manufacturing, and cost.

Flow through the conduits 1706, 1708 (see double-headed arrows 1712 in FIG. 17B) may allow flow into and out of the pyrolysis chamber 300 and the tubular ducts 310, respectively.

In some embodiments, only one of the tubular ducts 310 may have a port 1708.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, non-electric motors may be used to drive the lateral screw conveyer and the central shaft of the screw conveyer. Yet further modifications could be implemented by a person of ordinary skill in the art in view of the present disclosure, which modifications would be within the scope of the present technology.

The term “connected” or “coupled to” may include both direct coupling (in which two elements that are coupled to each other contact each other) and indirect coupling (in which at least one additional element is located between the two elements).

What is claimed is:

1. A pyrolysis system configured to receive material for pyrolysis, comprising:
a heating chamber configured to receive hot gas;
one or more ports for metering fuel and oxidizer to the heating chamber for combustion in the heating chamber; and
a pyrolysis chamber for holding the material during pyrolysis in isolation from the hot gas in the heating chamber, the pyrolysis chamber being disposed inside the heating chamber to circumferentially heat the material in the pyrolysis chamber and being configured to convey the material through the pyrolysis chamber.

2. The system of claim 1, further comprising a screw conveyer disposed inside the pyrolysis chamber to convey the material through the pyrolysis chamber.

3. The system of claim 2, wherein the screw conveyer extends longitudinally between an inlet and an outlet of the pyrolysis chamber, the one or more ports define one or more longitudinally distributed sections of the pyrolysis chamber.

4. The system of claim 1, wherein the hot gas carries waste heat recovered from an industrial process that is upstream of the heating chamber, a temperature of the hot gas being configured to enable autoignition of the fuel and the oxidizer inside the heating chamber.

5. The system of claim 1, wherein the hot gas carries a first portion of heat generated for use in an industrial process that is upstream of the heating chamber, a second portion of the heat being consumed in the industrial process.

6. The system of claim 5, wherein the heat is generated by combustion, the hot gas being a product of the combustion.

7. The system of claim 5, wherein the industrial process is power generation.

8. The system of claim 1, wherein the hot gas has a temperature above 300° C.

9. The system of claim 1, wherein the material pyrolyzes to generate solid carbon, and the fuel and oxidizer are metered to control pyrolysis processes to control a physical property of the solid carbon.

10. The system of claim 1, wherein the one or more ports include ports configured to introduce cooling fluid into the heating chamber.

11. The system of claim 1, further comprising one or more tubular ducts disposed inside the heating chamber and connected to the pyrolysis chamber to selectively receive intermediate products from the pyrolysis chamber.

12. The pyrolysis system of claim 11, further comprising a plurality of ports formed in the tubular ducts for selectively drawing out pyrolysis products from the tubular ducts, the plurality of ports being longitudinally separated along the tubular ducts.

13. The system of claim 11, wherein the tubular ducts are disposed above the pyrolysis chamber to preferentially receive relatively lighter intermediate products from the pyrolysis chamber.

14. The system of claim 13, wherein the intermediate products are gaseous, and the tubular ducts are fluidly connected to the pyrolysis chamber to hinder flow of solids through the tubular ducts.

15. The system of claim 1, further comprising a catalysis chamber disposed inside the heating chamber and fluidly connected to the pyrolysis chamber, the catalysis chamber including catalysts heated by the heating chamber for facilitating pyrolysis.

16. The system of claim 15, wherein the catalysis chamber is separate from the pyrolysis chamber.

17. The system of claim 1, wherein the one or more ports include a plurality of fuel ports fluidly connected to a plurality of fuel nozzles circumferentially distributed around the pyrolysis chamber to inject fuel into the heating chamber to cause mixing inside the heating chamber.

18. The system of claim 17, wherein the nozzles are configured to generate fuel jets ejecting into the heating chamber.

19. The system of claim 1, further comprising a burner disposed at a longitudinal end of the heating chamber for initiating a combustion reaction in the heating chamber.

20. The system of claim 1, wherein the pyrolysis system is a system for generating hydrogen, and the material includes methane.

21. The system of claim 1, wherein the material includes plastic.

22. The system of claim 1, further comprising a fan fluidly connected to the pyrolysis chamber to depressurize the pyrolysis chamber to below atmospheric pressure.

23. The system of claim 1, further comprising
a valve connected to the heating chamber and actuatable to meter at least one of the fuel or the oxidizer to the heating chamber;
a sensor for sensing a temperature for pyrolysis; and
a controller connected to the valve to actuate the valve to control the fuel supplied to the heating chamber based on the temperature sensed by the sensor to control pyrolysis of the material.

24. The system of claim 23, wherein the sensor is a first sensor, the system further comprising:
a second sensor for sensing a quantity indicative of pressure in the pyrolysis chamber; and
a fan fluidly connected to the pyrolysis chamber to depressurize the pyrolysis chamber to below atmospheric pressure, the controller being connected to the fan to actuate the fan to control suction provided by the fan to the pyrolysis chamber, based on the quantity sensed by the second sensor to maintain the pressure in the pyrolysis chamber.

25. The system of claim 1, wherein the material generates gas as it is pyrolyzed to reduce solid mass of the material, the system further comprising:
a screw conveyer disposed inside the pyrolysis chamber and receiving the material to convey the material along the pyrolysis chamber as it is pyrolyzed in the pyrolysis chamber, the screw conveyer including a flight configured to facilitate pyrolysis by compacting the material as the solid mass of the material is reduced.

26. The pyrolysis system of claim 25, wherein a geometry of the flight is configured based on at least one of the solid mass of the material, a texture of the material, or a porosity of the material, to facilitate pyrolysis.

27. The pyrolysis system of claim 25, wherein the screw conveyer includes a plurality of paddles extending radially outwardly from the flight to cause mixing of the material while it is conveyed through the pyrolysis chamber.

28. The pyrolysis system of claim 25, wherein the screw conveyer is configured to draw the material from a first portion of the screw conveyer to a second portion of the screw conveyer, a pitch of the flight being smaller in the second portion of the screw conveyer relative to the first portion.

29. The pyrolysis system of claim 28, wherein the second portion of the screw conveyer is integrally formed with the first portion.

30. The pyrolysis system of claim 28, wherein the pitch of the flight is constant in at least one of the first portion or the second portion of the screw conveyer.

31. The pyrolysis system of claim 28, wherein the pitch of the flight in the second portion of the screw conveyer is less than half of the pitch of the flight in the first portion of the screw conveyer.

32. The pyrolysis system of claim 28, wherein the screw conveyer is configured to draw the material from the second portion of the screw conveyer to a third portion of the screw conveyer, a pitch of the flight being smaller in the third portion of the screw conveyer relative to the second portion.

33. The pyrolysis system of claim 28, wherein the screw conveyer is configured to draw the material from an inlet portion of the screw conveyer to the first portion of the screw conveyer, the inlet portion being integrally formed with the first portion, the flight in the inlet portion being tapered such that the material is drawn substantially evenly from an inlet end of the inlet portion to the first portion of the screw conveyer.

34. The pyrolysis system of claim 1, further comprising a sliding seal connecting the pyrolysis chamber to an outlet, the sliding seal allowing sliding of a longitudinal end of the pyrolysis chamber within a sleeve while maintaining sealing to prevent intrusion of ambient air into the pyrolysis chamber.

35. The pyrolysis system of claim 1, further comprising a plurality of baffles disposed in the heating chamber to guide fluid in the heating chamber, the plurality of baffles being staggered along the pyrolysis chamber to encourage uniform heating of the pyrolysis chamber and to prolong residence time of fluids in the heating chamber.

36. The pyrolysis system of claim 35, wherein the plurality of baffles are configured to cause a zig-zag flow to improve heat distribution and reduce cold spots in the pyrolysis chamber.

37. The pyrolysis system of claim 1, further comprising a plurality of ports formed in the pyrolysis chamber for selectively drawing out pyrolysis products from the pyrolysis chamber, the plurality of ports being longitudinally separated along the pyrolysis chamber.

38. The pyrolysis system of claim 1, further comprising a plurality of ports formed in the pyrolysis chamber for selectively inject substances into the pyrolysis chamber, the plurality of ports being longitudinally separated along the pyrolysis chamber.

39. A module for a pyrolysis system configured to receive material for pyrolysis, comprising:
a heating chamber section configured to receive hot gas;
one or more ports configured to meter fuel and oxidizer to the heating chamber section; and
a pyrolysis chamber section configured to hold the material during pyrolysis in isolation from the hot gas, the pyrolysis chamber section being disposed inside the heating chamber section to circumferentially heat the material in the pyrolysis chamber.

40. A pyrolysis system comprising at least two of the modules defined in claim 39 fluidly connected in sequence to define a pyrolysis chamber disposed inside a heating chamber, the pyrolysis chamber holding the material for pyrolysis in fluid isolation from the hot gas, the heating chamber receiving the hot gas and combusting fuel to heat the material in the pyrolysis chamber.

41. The pyrolysis system of claim 40, further comprising a screw conveyer disposed inside the pyrolysis chamber to convey the material through the pyrolysis chamber between an inlet and an outlet of the pyrolysis system.

42. A method for pyrolyzing material, comprising:
conveying the material through a pyrolysis chamber disposed inside of and fluidly isolated from a heating chamber;
heating the material in the pyrolysis chamber circumferentially by introducing hot gas into the heating chamber around the pyrolysis chamber; and
combusting fuel in the heating chamber to heat the material to cause pyrolysis of the material.

43. The method of claim 42, further comprising receiving cooling fluid into the heating chamber to control a temperature in the heating chamber to control pyrolysis processes in the pyrolysis chamber.

44. The method of claim 43, further comprising metering fuel to the heating chamber to control the temperature in the heating chamber to control pyrolysis processes in the pyrolysis chamber.

45. The method of claim 43, further comprising metering oxidizer to the heating chamber to control the temperature in the heating chamber to control pyrolysis processes in the pyrolysis chamber.

46. The method of any one of claim 44 or 45, wherein the temperature in the heating chamber is controlled based on a temperature sensed in the pyrolysis chamber.

47. The method of claim 42, further comprising:
generating heat for use in an industrial process that is upstream of the heating chamber;
using the hot gas to carry a first portion of the heat to the heating chamber; and
consuming a second portion of the heat in the industrial process.

48. The method of claim 47, wherein generating the heat for use in the industrial process that is upstream of the heating chamber includes generating heat by combustion, the hot gas being a product of the combustion.

49. The method of claim 47, wherein the industrial process is power generation.

50. The method of claim 42, wherein pyrolysis of the material generates pyrolysis products, the method further comprising:
drawing the pyrolysis products out of the pyrolysis chamber through the heating chamber while keeping the pyrolysis products fluidly isolated from the heating chamber.

51. The method of claim 42, wherein pyrolysis of the material generates first pyrolysis products and second pyrolysis products, the first pyrolysis products being lighter than the second pyrolysis products, the method further comprising:
drawing the first pyrolysis products away from the pyrolysis chamber separately from the second pyrolysis products by allowing the first pyrolysis products to rise above the second pyrolysis products to separate from the second pyrolysis products.

52. The method of claim 42, wherein the pyrolysis of the material generates pyrolysis products, the method further comprising:
drawing gaseous pyrolysis products out of the pyrolysis chamber through the heating chamber while keeping the gaseous pyrolysis products fluidly isolated from the heating chamber; and
hindering solid pyrolysis products from leaving the pyrolysis chamber with the gaseous pyrolysis products.

53. The method of claim 42, further comprising:
heating catalysts using the heating chamber while keeping the catalysts fluidly isolated from the heating chamber; and
using the catalysts to facilitate pyrolysis in the pyrolysis chamber.

54. The method of claim 42, further comprising ejecting a plurality of fuel jets into the heating chamber and circumferentially around the pyrolysis chamber for combustion around the pyrolysis chamber.

55. The method of claim 54, further comprising ejecting a plurality of oxidizer jets into the heating chamber and circumferentially around the pyrolysis chamber for reaction with fuel from the plurality of fuel jets.

56. The method of claim 42, wherein the material includes a hydrocarbon, and pyrolysis of the material is configured to generate hydrogen and solid carbon, the method further comprising using the solid carbon in the pyrolysis chamber to enhance pyrolysis of the hydrocarbon to generate hydrogen.

57. The method of claim 56, further comprising supplying water and oxygen to the pyrolysis chamber to cause a water gas shift reaction.

58. The method of claim 56, wherein the hydrocarbon is methane.

59. The method of claim 56, wherein the material includes waste material.

60. The method of claim 42, wherein the pyrolysis of the material generates a fuel, the method further comprising:
combusting the fuel in the heating chamber to provide heat to the pyrolysis chamber.

61. The method of claim 60, wherein the pyrolysis of the material generates solid carbon that is granular, the method further comprising:
cyclonically separating the fuel from the solid carbon before combusting the fuel in the heating chamber.

62. The method of claim 42, wherein the material is a mixed waste stream including a first material and a second material, the method further comprising:
generating a first group of pyrolysis products by pyrolyzing, in the pyrolysis chamber, the mixed waste stream under conditions configured to cause pyrolysis of the first material and hinder pyrolysis of the second material;
drawing out the first group of pyrolysis products from the pyrolysis chamber to generate a residual waste stream, in the pyrolysis chamber, that includes the second material; and
generating a second group of pyrolysis products by pyrolyzing, in the pyrolysis chamber, the residual waste stream under conditions configured to cause pyrolysis of the second material.

63. The method of claim 62, wherein
generating the first group of pyrolysis products by pyrolyzing, in the pyrolysis chamber, the mixed waste stream under conditions configured to cause pyrolysis of the first material and hinder pyrolysis of the second material includes causing pyrolysis of the first material in a first portion of the pyrolysis chamber;
generating the second group of pyrolysis products by pyrolyzing, in the pyrolysis chamber, the residual waste stream under conditions configured to cause pyrolysis of the second material includes causing pyrolysis of the second material in a second portion of the pyrolysis chamber;
conveying the material through the pyrolysis chamber disposed inside of and fluidly isolated from the heating chamber includes conveying the mixed waste stream through the first portion of the pyrolysis chamber as the mixed waste stream is being pyrolyzed; and
the method further comprising conveying the second material through the second portion of the pyrolysis chamber as the second material is being pyrolyzed.

64. The method of claim 42, wherein the material is a mixed waste stream including a first material and a second material, the pyrolysis chamber is a first pyrolysis chamber, the method further comprising:
generating a first group of pyrolysis products by pyrolyzing, in the first pyrolysis chamber, the mixed waste stream under conditions configured to cause pyrolysis of the first material and hinder pyrolysis of the second material;
separating out the first group of pyrolysis products to generate a residual waste stream including the second material; and
generating a second group of pyrolysis products by pyrolyzing the residual waste stream, in a second pyrolysis chamber separate from the first pyrolysis chamber, under conditions configured to cause pyrolysis of the second material.

65. The method of claim 64, wherein the heating chamber is a first heating chamber, the hot gas is a first hot gas, the fuel is a first fuel, and the step of generating the second group of pyrolysis products by pyrolyzing the residual waste stream, in a second pyrolysis chamber separate from the first pyrolysis chamber, under conditions configured to cause pyrolysis of the second material includes
conveying the residual waste stream through the second pyrolysis chamber, the second pyrolysis chamber disposed inside of and fluidly isolated from the second heating chamber;
heating the residual waste stream in the second pyrolysis chamber circumferentially by introducing a second hot gas into a second heating chamber around the second pyrolysis chamber; and
combusting a second fuel in the heating chamber to heat the residual waste stream to cause pyrolysis of the residual waste stream.

66. The method of claim 42, wherein the material is dried biomass, combusting fuel in the heating chamber to heat the material to cause pyrolysis of the material includes combusting a hydrocarbon fuel generated by pyrolysis of dried biomass to generate heat and first waste gas, the dried biomass and second waste gas being generated by drying of wet biomass, the first waste gas and second waste gas being used for drying of wet biomass.

67. The method of claim 42, wherein pyrolyzing the material reduces solid mass of the material, the method further comprising:
compacting the material in the pyrolysis chamber to facilitate pyrolysis as the solid mass of the material is reduced due to pyrolysis.

68. The method of claim 67, wherein compacting the material in the pyrolysis chamber to facilitate pyrolysis as the solid mass of the material is reduced includes
conveying the material through the pyrolysis chamber as the material is pyrolyzed to compact the material.

69. The method of claim 67, wherein conveying the material through the pyrolysis chamber as the material is pyrolyzed to compact the material includes using a screw conveyer defining a flight having variable pitch to convey the material.

70. The method of claim 67, further comprising mixing the material in the pyrolysis chamber as the solid mass of the material is reduced.

71. A method of processing a mixed waste stream including a first material and a second material, the method comprising:
generating a first group of pyrolysis products by pyrolyzing the mixed waste stream under conditions configured to cause pyrolysis of the first material and hinder pyrolysis of the second material;
separating out the first group of pyrolysis products to generate a residual waste stream including the second material; and
generating a second group of pyrolysis products by pyrolyzing the residual waste stream under conditions configured to cause pyrolysis of the second material.

72. The method of claim 71, wherein the mixed waste stream includes plastics and organic waste.

73. The method of claim 71, wherein the pyrolysis of the first material and the pyrolysis of the second material occur in separate pyrolysis chambers.

74. The method of claim 71, wherein the pyrolysis of the first material and the pyrolysis of the second material occur in separate portions of a pyrolysis chamber.

75. The method of claim 71, wherein the pyrolysis of the first material and the pyrolysis of the second material is achieved below atmospheric pressure.

76. The method of claim 71, wherein generating a first group of pyrolysis products by pyrolyzing the mixed waste stream under conditions configured to cause pyrolysis of the first material and hinder pyrolysis of the second material includes causing pyrolysis of the first material in a pyrolysis chamber heated by combustion in a heating chamber, and metering fuel to the heating chamber to control a temperature of the pyrolysis chamber.

77. The method of claim 71, wherein the conditions configured to cause pyrolysis of the first material and hinder pyrolysis of the second material include a first temperature and a first pressure, and the conditions configured to cause pyrolysis of the second material include a second temperature and a second pressure.

78. The method of claim 71, wherein the second group of pyrolysis products includes a fuel, the fuel being combusted for generating power.

79. The method of claim 78, wherein hot gases generated by combusting the fuel are used for causing pyrolysis.

80. A system for processing a mixed waste stream including a first material and a second material, the system comprising:
a first pyrolysis chamber configured to receive the mixed waste stream and heat to generate a first group of pyrolysis products by pyrolyzing the mixed waste stream under conditions configured to cause pyrolysis of the first material and hinder pyrolysis of the second material; and
a second pyrolysis chamber, separate from the first pyrolysis chamber, the second pyrolysis chamber configured to receive heat and a residual waste stream to generate a second group of pyrolysis products by pyrolyzing the residual waste stream under conditions configured to cause pyrolysis of the second material, the residual waste stream being received via the first pyrolysis chamber by separating out the first group of pyrolysis products after pyrolysis of the first material of the mixed waste stream.

81. The system of claim 80, further comprising
a first heating chamber configured to receive fuel for combustion to heat the first pyrolysis chamber;
a valve connected to the first heating chamber and actuatable to meter the fuel to the heating chamber
a sensor for sensing a temperature for pyrolysis; and
a controller connected to the valve to actuate the valve to control the fuel supplied to the heating chamber based on the temperature sensed by the sensor and the conditions configured to cause pyrolysis of the first material and hinder pyrolysis of the second material.

82. The system of claim 81, wherein the temperature is at least one of a temperature of the first heating chamber or a temperature of the first pyrolysis chamber.

83. A method of generating power using wet biomass, the method comprising:
combusting a fuel generated by pyrolysis of dried biomass to generate heat and first waste gas, the dried biomass and second waste gas being generated by drying of wet biomass, the first waste gas and second waste gas being used for drying of wet biomass; and
using the heat to generate power.

84. The method of claim 83, wherein using the heat to generate power includes
generating shaft power using the heat generated by combusting the fuel, and
using the shaft power to generate electrical power.

85. The method of claim 83, wherein the pyrolysis of the dried biomass generates pyrolysis-generated fuel to be used for combustion to generate heat for pyrolysis.

86. The method of claim 83, wherein combusting the fuel includes reacting the fuel with an oxidizer, the oxidizer including oxygen and carbon dioxide, and the method further comprises:
processing at least a portion of the second waste gas to generate the carbon dioxide in the oxidizer.

87. The method of claim 83, wherein the fuel is a hydrocarbon fuel.

88. A pyrolysis system configured to receive material for pyrolysis, comprising:
a pyrolysis chamber for holding the material during pyrolysis of the material, a solid mass of the material in the pyrolysis chamber being varied due to pyrolysis; and
a screw conveyer disposed inside the pyrolysis chamber and receiving the material to convey the material along the pyrolysis chamber as it is pyrolyzed in the pyrolysis chamber, the screw conveyer including a flight configured to compact the material based on the solid mass of the material during pyrolysis to facilitate pyrolysis.

89. The pyrolysis system of claim 88, wherein the flight is configured based on at least one of the solid volume of the material, solid mass of the material, a texture of the material, or a porosity of the material, to facilitate pyrolysis.

90. The pyrolysis system of claim 88, wherein the screw conveyer includes a plurality of paddles extending radially outwardly from the flight to cause mixing of the material while it is conveyed through the pyrolysis chamber.

91. The pyrolysis system of claim 88, wherein the screw conveyer is configured to draw the material from a first portion of the screw conveyer to a second portion of the screw conveyer, a pitch of the flight being different in the second portion of the screw conveyer relative to the first portion.

92. The pyrolysis system of claim 91, wherein the second portion of the screw conveyer is integrally formed with the first portion.

93. The pyrolysis system of claim 91, wherein the pitch of the flight is constant in at least one of the first portion or the second portion of the screw conveyer.

94. The pyrolysis system of claim 91, wherein the pitch of the flight in the second portion of the screw conveyer is less than half of the pitch of the flight in the first portion of the screw conveyer.

95. The pyrolysis system of claim 91, wherein the screw conveyer is configured to draw the material from the second portion of the screw conveyer to a third portion of the screw conveyer, a pitch of the flight being different in the third portion of the screw conveyer relative to the second portion.

96. The pyrolysis system of claim 91, wherein the screw conveyer is configured to draw the material from an inlet portion of the screw conveyer to the first portion of the screw conveyer, the inlet portion being integrally formed with the first portion, the flight in the inlet portion being tapered such that the material is drawn substantially evenly from an inlet end of the inlet portion to the first portion of the screw conveyer.

97. A method for pyrolyzing material, comprising:
heating the material in a pyrolysis chamber to pyrolyze the material to vary solid mass of the material; and
compacting the material in the pyrolysis chamber to facilitate pyrolysis as the solid mass of the material is varied due to pyrolysis.

98. The method of claim 97, wherein compacting the material in the pyrolysis chamber to facilitate pyrolysis as the solid mass of the material is varied includes
conveying the material through the pyrolysis chamber as the material is pyrolyzed to compact the material.

99. The method of claim 97, wherein conveying the material through the pyrolysis chamber as the material is pyrolyzed to compact the material includes
using a screw conveyer defining a flight having variable pitch to convey the material.

100. The method of claim 97, further comprising mixing the material in the pyrolysis chamber as the solid mass of the material is reduced.
